(19) United States
(12) Patent Application Publication
(10) Pub. No.: US 2025/0245579 A1
(43) Pub. Date: Jul. 31, 2025

(54) TRANSPORTATION PLANNING APPARATUS AND METHOD

(71) Applicant: Hitachi, Ltd., Tokyo (JP)

(72) Inventors: Hang DONG, Tokyo (JP); Junko HOSODA, Tokyo (JP); Akane SETO, Tokyo (JP); Kazuya UYAMA, Tokyo (JP)

(21) Appl. No.: 18/961,838

(22) Filed: Nov. 27, 2024

(30) Foreign Application Priority Data
Jan. 25, 2024 (JP) 2024-009400

(51) Int. Cl. G06Q 10/0631

(52) U.S. Cl. CPC G06Q 10/06311

(57) ABSTRACT

There is provided a relay transportation planning apparatus and method capable of devising a relay transportation plan(s) which enhances package transportation efficiency. A transportation plan is created by forming one or a plurality of transportation groups by gathering packages which have an at least partly overlapping transportation route and share a common time slot for transportation via the transportation route, based on package information, vehicle information, and driver information and allocating a transportation vehicle and a driver to each of the created transportation groups, wherein the transportation planning apparatus is designed to allocate a plurality of transportation vehicles which perform platooning or a transportation vehicle for towing a plurality of towed vehicles to the transportation group(s) when necessary.

### CROSS-REFERENCE TO RELATED APPLICATION

The present application claims priority from Japanese application JP2024-009400, filed on Jan. 25, 2024, the content of which is hereby incorporated by reference into this application.

### TECHNICAL FIELD

The present invention relates to a transportation planning apparatus and method and is suited for application to, for example, a relay transportation planning apparatus for devising a transportation plan for a plurality of packages via a relay base.

### BACKGROUND ART

Conventionally, when the destination of a package(s) to be transported is a remote place, relay transportation is conducted by a plurality of drivers to share the transportation by handing over the package(s) to another driver at a base located in the middle of a transportation route. As a technology to efficiently devise a plan for the relay transportation (hereinafter referred to as a “relay transportation plan”), there is a technology described in, for example, PTL 1.

This PTL 1 discloses the technology designed to enable a delivery plan apparatus to efficiently cope with delivery requirements regarding which a loading location and an unloading location, a package amount, a vehicle-carrying vehicle, and a crew members' work shift change flexibly, by providing the delivery plan apparatus with: a delivery request registration unit that accepts and registers one or a plurality of delivery requests for a delivery/deliveries between specified locations; an area-of-responsibility creation unit that divides the delivery request into deliveries to one or a plurality of areas in which a crew member of a delivery vehicle takes charge; and a vehicle route planning unit that identifies a delivery route and a cost relating to the delivery for each combination of a relay point candidate between the areas and a relay time of day at the relay point candidate and identifies the delivery route as a vehicle route by using the cost.

### CITATION LIST

### Patent Literature

PTL 1: Japanese Patent Application Laid-Open (Kokai) Publication No. 2020-4181

### SUMMARY OF THE INVENTION

### Problems to be Solved by the Invention

Meanwhile, when devising a relay transportation plan in general, a plan for a driver to drive a transportation vehicle such as a truck from a specified departure base to go to a relay base and transport packages loaded onto the transportation vehicle at the relay base is devised. Regarding the above-described conventional method for devising a relay transportation plan, if the driver's movement matches the transportation vehicle's movement and there is no package to be transported from the driver's departure base to the relay base, a plan for that driver to drive an empty vehicle (a transportation vehicle on which no package is loaded) to travel to the relay base is devised.

However, driving an empty vehicle is still the driver's labor regardless of the transportation of no packages, so that there was a problem of degradation in transportation efficiency, that is, a transportation amount per driver.

The present invention was devised in consideration of the above-described circumstances and aims at proposing a transportation planning apparatus and method capable of devising a transportation plan which enhances package transportation efficiency.

### Means to Solve the Problems

In order to solve the above-described problem, there is provided according to the present invention a transportation planning apparatus for creating transportation plans to transport packages for which transportation requests are made, wherein the transportation planning apparatus includes: a storage unit that stores and retains package information which is information about each of the requested packages, vehicle information which is information about each of transportation vehicles for transporting the packages, and driver information which is information about each of drivers who drive the transportation vehicles, respectively; and a control unit that creates the transportation plan by forming one or a plurality of transportation groups by gathering the packages which have an at least partly overlapping transportation route and share a common time slot for transportation via the transportation route, based on the package information, the vehicle information, and the driver information and allocating the transportation vehicle and the driver to each of the created transportation groups, wherein the control unit allocates a plurality of the transportation vehicles, which perform platooning, or the transportation vehicle for towing a plurality of towed vehicles to the transportation group as necessary.

Moreover, there is provided according to the present invention a transportation planning method executed by a transportation planning apparatus for creating transportation plans to transport packages for which transportation requests are made, wherein the transportation planning method includes: a first step of storing and retaining package information which is information about each of the requested packages, vehicle information which is information about each of transportation vehicles for transporting the packages, and driver information which is information about each of drivers who drive the transportation vehicles, respectively; and a second step of creating the transportation plan by forming one or a plurality of transportation groups by gathering the packages which have an at least partly overlapping transportation route and share a common time slot for transportation via the transportation route, based on the package information, the vehicle information, and the driver information and allocating the transportation vehicle and the driver to each of the created transportation groups, wherein in the second step, the transportation planning apparatus allocates a plurality of the transportation vehicles, which perform platooning, or the transportation vehicle for towing a plurality of towed vehicles to the transportation group as necessary.

The above-described transportation planning apparatus and method according to the present invention allocates the transportation vehicle and the driver separately to a transportation group(s), it is possible to prevent the degradation in the package transportation efficiency attributable to driving an empty vehicle. Additionally, the transportation planning apparatus and method according to the present invention allocates a plurality of transportation vehicles, which perform platooning, or a transportation vehicle for towing a plurality of towed vehicles to a transportation group as necessary, it is possible to increase the transportation amount per driver.

### Advantageous Effects of the Invention

The transportation planning apparatus and method capable of devising transportation plans which enhance the package transportation efficiency can be implemented according to the present invention.

### BRIEF DESCRIPTION OF DRAWINGS

FIG. 1 is a block diagram illustrating a hardware configuration of a relay transportation planning system according to first to third embodiments;

FIG. 2 is a block diagram illustrating a logical configuration of the relay transportation planning system according to the first embodiment;

FIG. 3 is a chart illustrating a structure example of a package information table;

FIG. 4 is a chart illustrating a structure example of a vehicle information table;

FIG. 5 is a chart illustrating a structure example of a driver information table;

FIG. 6 is a chart illustrating a structure example of a base information table;

FIG. 7 is a chart illustrating a structure example of a travel cost information table;

FIG. 8 is a chart illustrating a structure example of an evaluation information table;

FIG. 9 is a chart illustrating a structure example of a relay base candidate information table;

FIG. 10 is a chart illustrating a structure example of a transportation group information table;

FIG. 11 is a chart illustrating a structure example of a proposed relay transportation plan information table;

FIG. 12 is a flowchart illustrating a processing sequence for relay transportation plan devising processing;

FIG. 13 is a flowchart illustrating a processing sequence for transportation group creation processing;

FIG. 14 is a flowchart illustrating a processing sequence for proposed relay transportation plan creation processing;

FIG. 15 is a flowchart illustrating a processing sequence for proposed relay transportation plan evaluation processing;

FIG. 16 is a diagram illustrating a screen configuration example of a result summary display screen;

FIG. 17 is a diagram illustrating a screen configuration example of a driver schedule display screen;

FIG. 18 is a diagram illustrating a screen configuration example of a transportation schedule display screen;

FIG. 19 is a diagram illustrating a screen configuration example of a base plan display screen;

FIG. 20 is a block diagram illustrating a logical configuration of a relay transportation planning system according to a second embodiment;

FIG. 21 is a chart illustrating a structure example of a transportation apparatus information table;

FIG. 22 is a block diagram illustrating a logical configuration of a relay transportation planning system according to a third embodiment; and

FIG. 23 is a chart illustrating a structure example of a berth information table.

### DESCRIPTION OF EMBODIMENTS

An embodiment of the present invention will be described below in detail with reference to the drawings.

Incidentally, the embodiment described below is an example for explaining the present invention and some omissions and simplification are made as appropriate for clarity of explanation. The present invention can be implemented in various other forms. Unless otherwise limited, each constituent element may be singular or plural.

The location, size, shape, range, and so on of each constituent element indicated in the drawings may not represent the actual location, size, shape, range, etc. in order to facilitate understanding of the invention. Therefore, the present invention is not necessarily limited to the locations, sizes, shapes, ranges, etc. disclosed in the drawings.

Examples of various types of information may be described in expressions such as “table,” “list,” and “queue,” but the various types of information may be expressed in other data structures. For example, various types of information such as an “XX table,” an “XX list,” and an “XX queue” may be expressed as “XX information.” When explaining identification information, expressions such as “identification information,” “identifier,” “name,” “ID,” and “number” are used, but they can be replaced with each other.

If there are a plurality of constituent elements having the same or similar function, the same reference numeral with different subscripts may be used. Moreover, if it is unnecessary to distinguish between these multiple constituent elements, they may be described by omitting the subscripts.

In the embodiment, processing performed by executing a program may be described. Under this circumstance, a computer causes a processor (such as a CPU or a GPU) to execute a program(s) and perform processing defined by the program(s) while using storage resources (such as a memory), interface devices (such as communication ports), and so on. Therefore, the subject of the processing performed by executing the program may be the processor.

Similarly, the subject of the processing performed by executing the program may be a controller, an apparatus, a system, a computer, or a sheet which has the processor. The subject of the processing performed by executing the program may be an arithmetic unit and may include a dedicated circuit for performing specific processing. Under this circumstance, the dedicated circuit is, for example, an FPGA (Field Programmable Gate Array), an ASIC (Application Specific Integrated Circuit), or a CPLD (Complex Programmable Logic Device).

The program may be installed to the computer from a program source. The program source may be, for example, a program distribution server or a computer-readable storage medium. If the program source is the program distribution server, the program distribution server may include a processor and a storage resource for storing the target program to be distributed, and the processor of the program distribution server may distribute the target program to be distributed to other computers. Moreover, in the embodiment, two or more programs may be implemented as one program or one program may be implemented as two or more programs.

### (1) First Embodiment

### (1-1) Configuration of Relay Transportation Planning System According to this Embodiment

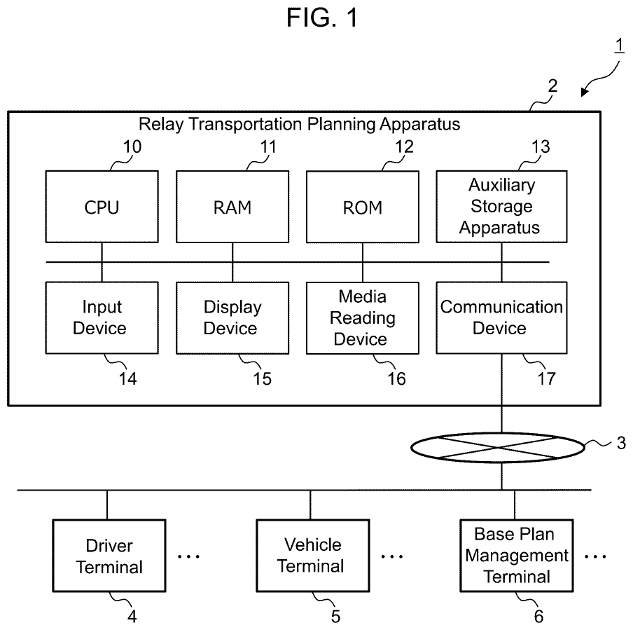

Referring to FIG. 1, the reference numeral 1 represents a relay transportation planning system according to this embodiment as a whole. This relay transportation planning system 1 is configured by including a relay transportation planning apparatus 2 and one or a plurality of driver terminals 4, vehicle terminal(s) 5, and base plan management terminal(s) 6 which are respectively connected freely communicably to this relay transportation planning apparatus 2 via a network 3.

Incidentally, a network 3 for connecting between the relay transportation planning apparatus 2 and each driver terminal 4 and a network 3 for connecting between the relay transportation planning apparatus 2 and each vehicle terminal 5 do not have to be the same network as a network 3 for connecting between the relay transportation planning apparatus 2 and each base plan management terminal 6. In the case of this embodiment, a wireless communication network such as a mobile terminal network or a wide area wireless network is assumed as the network 3 for connecting between the relay transportation planning apparatus 2 and each driver terminal 4 and the network 3 for connecting between the relay transportation planning apparatus 2 and each vehicle terminal 5, and a wired communication network such as the Internet is assumed as the network 3 for connecting between the relay transportation planning apparatus 2 and each base plan management terminal 6.

The relay transportation planning apparatus 2 is configured from a general-purpose computer apparatus equipped with a CPU (Central Processing Unit) 10, a RAM (Random Access Memory) 11, a ROM (Read Only Memory) 12, an auxiliary storage apparatus 13, an input device 14, a display device 15, a media reading device 16, and a communication device 17.

The CPU 10 is a processor that controls the operation of the entire relay transportation planning apparatus 2. Moreover, RAM 11 is configured from a volatile semiconductor memory and is used as a working memory of the CPU 10 to temporarily store various kinds of programs and various kinds of data. Furthermore, the ROM 12 is configured from a nonvolatile semiconductor memory and is used to store necessary programs to activate the relay transportation planning apparatus 2.

The auxiliary storage apparatus 13 is configured from a large-capacity nonvolatile storage apparatus(es) such as a hard disk drive(s) or an SSD(s) (Solid State Drive(s)) and is used to retain various kinds of programs, other than programs stored in the ROM 12, and information that need to be stored for a long period of time. Software stored in the auxiliary storage apparatus 13 is read from the RAM 11 by the CPU 10 when starting the relay transportation planning apparatus 2 or whenever necessary, and the CPU 10 executes the programs which have been read to the RAM 11, thereby executing various kinds of processing as the entire relay transportation planning apparatus 2 as described later.

The input device 14 is a device used by a user to input information to the relay transportation planning apparatus 2 and is configured from devices such as a keyboard and a mouse. Moreover, the display device 15 is configured from a liquid crystal display device, an organic EL (electro-luminescence) display device, or the like, and is used to display various kinds of information. Incidentally, instead of the input device 14 and the display device 15, a touch panel in which the input device 14 and the display device 15 are integrated together may be applied.

The media reading device 16 is a device for reading information stored in a portable storage medium such as a USB (Universal Serial Bus) memory. Moreover, the communication device 17 is a device equipped with a communication function to send and receive information between the respective driver terminals 4, the respective vehicle terminals 5, and the respective base plan management terminals 6 via the network 3 and is configured from, for example, a wired and/or wireless NIC (Network Interface Card).

The driver terminal 4 is a wireless communication terminal which each driver who drives a transportation vehicle carries with them, and is configured from, for example, a smartphone, a tablet, or a dedicated communication terminal. Moreover, the vehicle terminal 5 is a dedicated wireless communication terminal device mounted in each transportation vehicle and is configured by including a display device such as a small-sized liquid crystal display or organic EL display. The base plan management terminal 6 is a general-purpose computer device installed at each base.

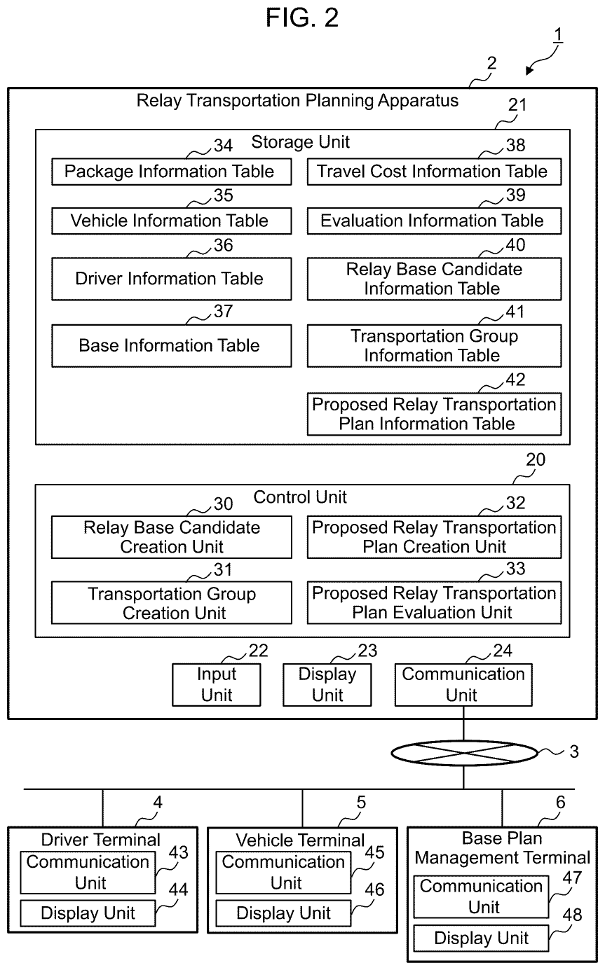

FIG. 2 illustrates a logical configuration of this relay transportation planning system 2. The relay transportation planning apparatus 2 is configured by including, as illustrated in this FIG. 2, a control unit 20, a storage unit 21, an input unit 22, a display unit 23, and a communication unit 24.

The control unit 20 is a functional unit embodied by execution of dedicated programs stored in the auxiliary storage apparatus 13 (FIG. 1) by the CPU 10 (FIG. 1). In the case of this embodiment, the control unit 20 includes, as functional units, a relay base candidate creation unit 30, a transportation group creation unit 31, a proposed relay transportation plan creation unit 32, and a proposed relay transportation plan evaluation unit 33 which will be described later.

Moreover, the storage unit 21 is a functional unit configured from the RAM 11, the ROM 12, and the auxiliary storage apparatus 13 described earlier with reference to FIG. 1. The storage unit 21 stores and retains a package information table 34, a vehicle information table 35, a driver information table 36, a base information table 37, a travel cost information table 38, an evaluation information table 39, a relay base candidate information table 40, a transportation group information table 41, and a proposed relay transportation plan information table 42 which will be described later.

The input unit 22 is a functional unit that accepts information which is input via the input device 14 (FIG. 1); and the display unit 23 is a functional unit that visualizes and displays necessary information on the display device 15 (FIG. 1). Moreover, the communication unit 24 is a functional unit having a function that communicates with the driver terminal(s) 4, the vehicle terminal(s) 5, and the base plan management terminal(s) 6 via the communication device 17 (FIG. 1).

Meanwhile, the driver terminal 4 is configured by including a communication unit 43 and a display unit 44. The communication unit 43 is a functional unit having a function that transmits the current status of a driver who carries the relevant driver terminal 4 with them to the relay transportation planning apparatus 2 and receives each driver's transportation schedule which has been transmitted from the relay transportation planning apparatus 2. Also, the display unit 44 is a functional unit having a function that visualizes and displays the transportation schedule, which is received by the communication unit 43, on a display device (which is not illustrated in the drawing) included by the relevant driver terminal 4.

Moreover, the vehicle terminal 5 is also configured by including a communication unit 45 and a display unit 46. The communication unit 45 is a functional unit having a function that transmits information about the current status of a transportation vehicle equipped with the vehicle terminal 5 and receives a transportation schedule about the transportation vehicle which has been transmitted from the relay transportation planning apparatus 2. Also, the display unit 46 is a functional unit having a function that visualizes and displays the transportation schedule received by the communication unit 45 on a display device (which is not illustrated in the drawing) included by that vehicle terminal 5.

Furthermore, the base plan management terminal 6 is similarly configured by including a communication unit 47 and a display unit 48. The communication unit 47 is a functional unit having a function that receives a task schedule, which has been transmitted from the relay transportation planning apparatus 2, at a base where the base plan management terminal 6 is installed. Also, the display unit 48 is a functional unit having a function that visualizes and displays the task schedule, which is received by the communication unit 47, on a display device (which is not illustrated in the drawing) included by the base plan management terminal 6.

### (1-2) Relay Transportation Plan Devising Function

Next, an explanation will be provided about a relay transportation plan devising function according to this embodiment which is mounted in the relay transportation planning apparatus 2. This relay transportation plan devising function is a function that creates a transportation plan by forming one or a plurality of transportation groups by gathering packages which have an at least partly overlapping transportation route and share a common time slot for transportation via the transportation route and allocating a transportation vehicle and a driver to each created transportation group.

Practically, the relay transportation planning apparatus 2 decides, with respect to each package transportation request (hereinafter referred to as an “order”), a base(s) which exists between a pickup location base of the relevant package and a delivery destination base as a candidate(s) for a relay base(s) for that package (hereinafter referred to as a “relay base candidate(s)”) and generates a combination of relay bases (hereinafter referred to as a “relay base combination”) for each order. Incidentally, if no appropriate base which can be an appropriate relay base exists between the pickup location base and the delivery destination base, the relay base does not have to be decided regarding that route.

Moreover, the relay transportation planning apparatus 2 divides a path from the pickup location base for packages of each order to the delivery destination base into a route from the pickup location base to the relay base candidate, a route from the relay base candidate to another relay base candidate, and a route from that relay base candidate to the delivery destination base. A combination of a starting point base and an ending point base in each route, and an order number of the relevant order will be hereinafter referred to as a “package route.”

However, in the following description, an explanation will be provided about a case where the number of the relay base candidates for each order is set as “0” or “1” for the sake of easier explanation and understanding. Accordingly, the package route for each order is divided into two package routes corresponding to the route from the pickup location base to the relay base candidate and the route from that relay base candidate to the delivery destination base, respectively, or is one package route from the pickup location base to the delivery destination base.

Furthermore, the relay transportation planning apparatus 2 identifies a possible departure time period from a starting point base and a possible arrival time period at an ending point base with respect to each package route obtained as described above for each order. Then, based on this identified result, the relay transportation planning apparatus 2 forms a group of all package routes which have matching starting points and ending points and regarding which both their possible departure time period from the starting point base and their possible arrival time period at the ending point base at least partly overlap with each other, as a transportation group.

Moreover, the relay transportation planning apparatus 2 creates a proposed relay transportation plan by allocating a transportation vehicle and driver that would satisfy transportation conditions, separately to each transportation group created as described above.

Furthermore, the relay transportation planning apparatus 2 evaluates each proposed relay transportation plan of the thus-created relay base combination. This evaluation can be conducted from various points of view. In this embodiment, the proposed relay transportation plan(s) is evaluated comprehensively from three points of view, that is, a “Delivery Delay” which is deadline delay time, “Operating Time” which is operating time of a transportation vehicle, and a “Driver's Satisfaction Level” which is a satisfaction level of the driver.

Then, the relay transportation planning apparatus 2 performs the above-described processing on respective relay base candidate combinations of all combination patterns obtained by changing relay base candidate bases or the quantity of relay base candidates of some or all the orders. Then, the relay transportation planning apparatus 2 extracts a relay base candidate combination which has the highest evaluation value and can be implemented, from among these relay base candidate combinations and presents the extracted relay base candidate combination as a relay transportation plan to the user.

Referring to FIG. 2, the storage unit 21 for the relay transportation planning apparatus 2 stores and retains, as means for implementing the above-described relay transportation planning function, the package information table 34, the vehicle information table 35, the driver information table 36, the base information table 37, the travel cost information table 38, the evaluation information table 39, the relay base candidate information table 40, the transportation group information table 41, and the proposed relay transportation plan information table 42; and the control unit 20 includes the relay base candidate creation unit 30, the transportation group creation unit 31, the proposed relay transportation plan creation unit 32, and the proposed relay transportation plan evaluation unit 33 as functional units.

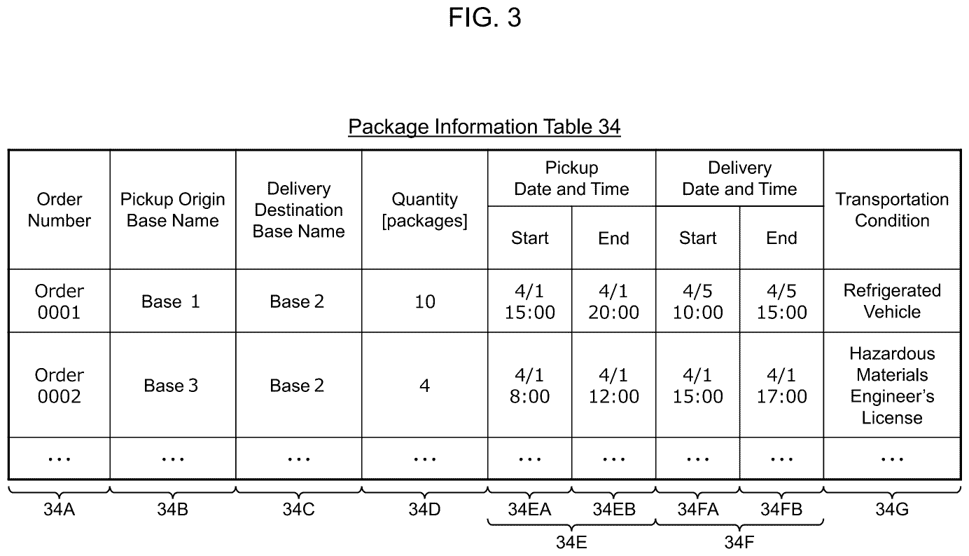

The package information table 34 is a table for managing various kinds of information about each package which is a transportation object (hereinafter referred to as “package information”) and is configured by including, as illustrated in FIG. 3, an order number column 34A, a pickup origin base name column 34B, a delivery destination base name column 34C, a quantity column 34D, a pickup date-and-time column 34E, a delivery date-and-time column 34F, and a transportation condition column 34G. In the package information table 34, one record (row) corresponds to a transportation object package for any one of orders.

Then, the order number column 34A stores a unique identification number (order number) assigned to the relevant order; and the pickup origin base name column 34B stores a unique name of the relevant base (base name) assigned to a pickup location base for the relevant package. Moreover, the delivery destination base name column 34C stores a base name of a delivery destination base for the relevant package; and the quantity column 34D stores the quantity of the relevant packages to be transported which is designed by the relevant order.

Furthermore, the pickup date-and-time column 34E is divided into a start column 34EA and an end column 34EB; and the start column 34EA stores a starting date and time of a time period during which the relevant package can be picked up at the pickup location base, and the end column 34EB stores an ending date and time of that time period. Similarly, the delivery date-and-time column 34F is divided into a start column 34FA and an end column 34FB; and the start column 34FA stores a starting date and time of a time period during which the relevant package can be delivered to the delivery destination base, and the end column 34FB stores an ending date and time of that time period.

Furthermore, the transportation condition column 34G stores a function requested for a transportation vehicle in charge of transportation of the relevant package or a condition such as a qualification which a driver who drives the relevant transportation vehicle should possess (hereinafter referred to as a “transportation condition(s)”). Examples of the above-described transportation condition(s) are a “Refrigerated Vehicle” which is a condition that the transportation vehicle should be a refrigerated vehicle, and a “Hazardous Materials Engineer's License” which is a condition that the driver should possess a qualification of a hazardous materials engineer's license.

Accordingly, in the case of an example in FIG. 3, it is shown that, for example, regarding transportation object packages of an order to which the order number “Order0001” is assigned, the pickup location is “Base 1,” the delivery destination is “Base 2,” and the quantity of the packages is “10.” FIG. 3 also shows that the dates and times when the packages can be picked up at the pickup location are from “4/1 15:00” (which means “15:00 on April 1^{st}”) to “4/1 20:00” (which means “20:00 on April 1^{st}”); and the dates and times when the packages can be delivered to the delivery destination are from “4/5 10:00” (which means “10:00 on April 5th”) to “4/5 15:00” (which means “15:00 on April 5th”); and it is requested as the transportation condition that the transportation vehicle should be a “Refrigerated Vehicle.”

Incidentally, the “quantity” in the package information may be, for example, “Volume-Controlled” indicating a total weight of the packages, a “Volume” or “Quantity” indicating a layer volume of the packages, a partial combination of the “Volume-Controlled” and the “Volume,” or a “Package Amount” indicating a package amount.

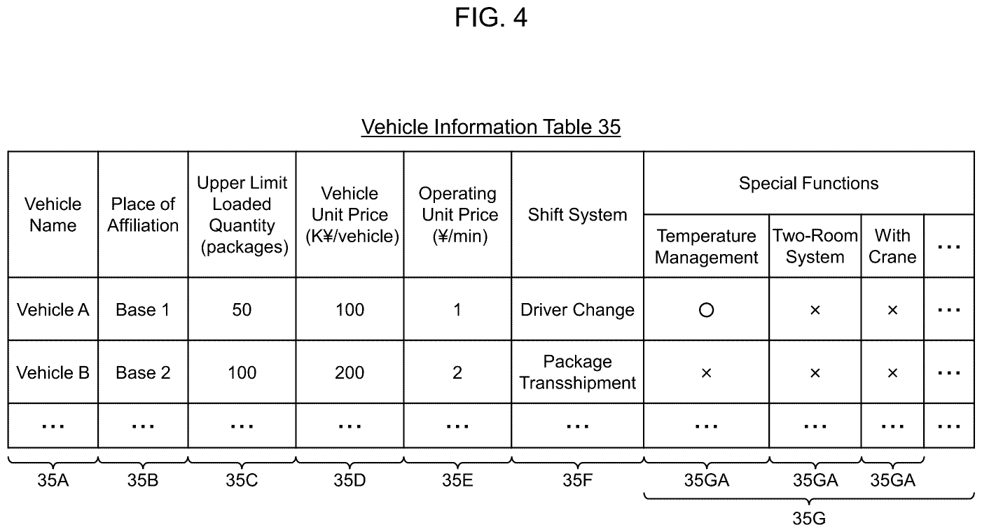

The vehicle information table 35 is a table for managing various kinds of information about each transportation vehicle which can be used to transport packages (hereinafter referred to as “vehicle information”) and is configured by including, as illustrated in FIG. 4, a vehicle name column 35A, a place-of-affiliation column 35B, an upper limit loaded quantity column 35C, a vehicle unit price column 35D, an operating unit price column 35E, a shift system column 35F, and a special functions column 35G. In the vehicle information table 35, one record corresponds to one transportation vehicle.

Then, the vehicle name column 35A stores a unique name of the relevant transportation vehicle allocated to that relevant transportation vehicle (vehicle name); and the place-of-affiliation column 35B stores the base name of a base to which that transportation vehicle belongs. Moreover, the upper limit loaded quantity column 35C stores an upper limit quantity of packages which can be loaded onto that transportation vehicle (hereinafter referred to as an “upper limit loaded quantity”); and the vehicle unit price column 35D stores an arrangement fee per transportation vehicle when using the transportation vehicle for the transportation (hereinafter referred to as a “vehicle unit price”).

Furthermore, the operating unit price column 35E stores a usage fee per unit time (for example, one minute) accrued when using the transportation vehicle to transport the packages (hereinafter referred to as a “operating unit price”); and the shift system column 35F stores a package delivery method at the relay base by the transportation vehicle. Example of the above-mentioned delivery method include a “Driver Change” to change the driver of the relevant transportation vehicle, a “Package Transshipment” to transship the packages from the transportation vehicle to another transportation vehicle, and a “Tractor Change” to change a tractor for the transportation vehicle.

Furthermore, the special functions column 35G is divided into a plurality of function columns 35GA respectively corresponding to some representative functions as functions mounted in the transportation vehicle; and these function columns 35GA store information indicating whether the transportation vehicle has the relevant function or not (in FIG. 4, “o” is stored when the transportation vehicle has the relevant function; and “x” is stored when the transportation vehicle does not have the relevant function). Incidentally, examples of the “representative functions mounted in the transportation vehicle” include “Temperature Management” capable of managing the temperature inside a loading platform(s) or a container(s), a “Two-Room System” where the inside of each loading platform or container is divided into two rooms whose temperature can be managed independently, and “With Crane” where a crane is mounted on the loading platform.

Accordingly, in the case of an example in FIG. 4, it is shown that regarding a transportation vehicle to which the vehicle name “Vehicle A” is assigned, the place of affiliation is “Base 1,” the upper limit loaded quantity is “50,” the vehicle unit price is “100 (kV)” per vehicle, the operating unit price is “1 (V)” per minute, the package delivery method at the relay base is the “Driver Change” system, and at least the “Temperature Management” function is mounted.

Incidentally, the “Upper Limit Loaded Quantity” in the vehicle information may be replaced with some or all of an “Upper Limit Loaded Weight” which is an upper limit for the loaded weight of the relevant transportation vehicle, an “Upper Limit Load Capacity” which is an upper limit for the load capacity of the transportation vehicle, a partial combination of the “Upper Limit Loaded Quantity,” the “Upper Limit Loaded Weight,” and “Upper Limit Load Capacity,” and an “Upper Limited Loaded Package Amount” which is an upper limit for the package amount which can be loaded onto the transportation vehicle. Moreover, a “Driver Unit Price” that is the driver's labor cost which accrues on the basis of the operating time of the transportation vehicle may be added to the vehicle information.

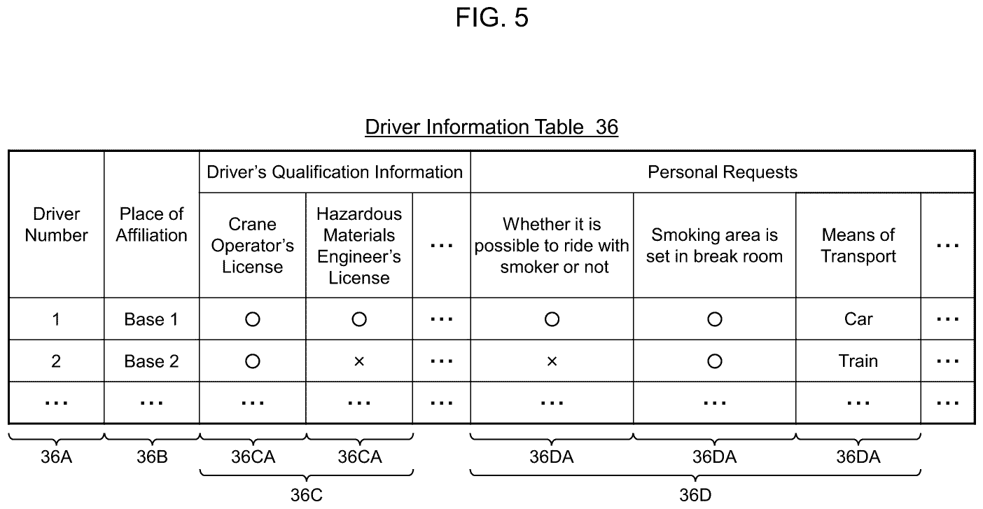

The driver information table 36 is a table for managing information about each driver who drives the transportation vehicle (hereinafter referred to as “driver information”) and is configured by included, as illustrated in FIG. 5, a driver number column 36A, a place-of-affiliation column 36B, a driver's qualification information column 36C, and a personal requests column 36D. In the driver information table 36, one record (row) corresponds to one driver.

Then, the driver number column 36A stores a unique identification number of the relevant driver which is assigned to that driver (a driver number); and the place-of-affiliation column 36B stores the base name of a base to which that driver belongs.

Moreover, the driver's qualification information column 36C is divided into a plurality of qualification information columns 36CA which respectively correspond to some representative licenses and qualifications that the driver can get; and each of these qualification information columns 36CA stores information indicating whether the driver possesses the relevant license or qualification (in FIG. 5, “o” is stored when the driver possesses the relevant license or qualification; and “x” is stored when the driver does not possess the relevant license or qualification). Examples of the “representative licenses and qualifications that the driver can get” include a “Crane Operator's License” which is a crane truck driving license, and a “Hazardous Materials Engineer's License” which is a qualification for a hazardous materials engineer. Moreover, in addition to these columns mentioned above, the qualification information columns 36CA corresponding to, for example, qualifications for carrying special packages or qualifications for locating special packages may be provided.

Furthermore, the personal requests column 36D is divided into a plurality of request columns 36DA respectively corresponding to some representative requests which can be considered as the driver's requests; and each of these request columns 36DA stores information indicating whether the driver has the relevant request or not (in FIG. 5, “o” is stored when the driver has the relevant request; and “x” is stored when the driver does not have that request) or specific content. Incidentally, examples of the “Driver's Representative Requests” include a vehicle type of the transportation vehicle which they drive, a fellow passenger of the driver when they drive, a person(s) to whom they deliver the packages, or facilities of the base where the driver passes through, and specific examples include “ride with a smoker” to accept riding with the smoker, a “smoking area is set” to request that the smoking area should be set in a break room of the base, and the “means of transport” (such as a car, a train(s), a bus(es)) when moving to any one of the bases.

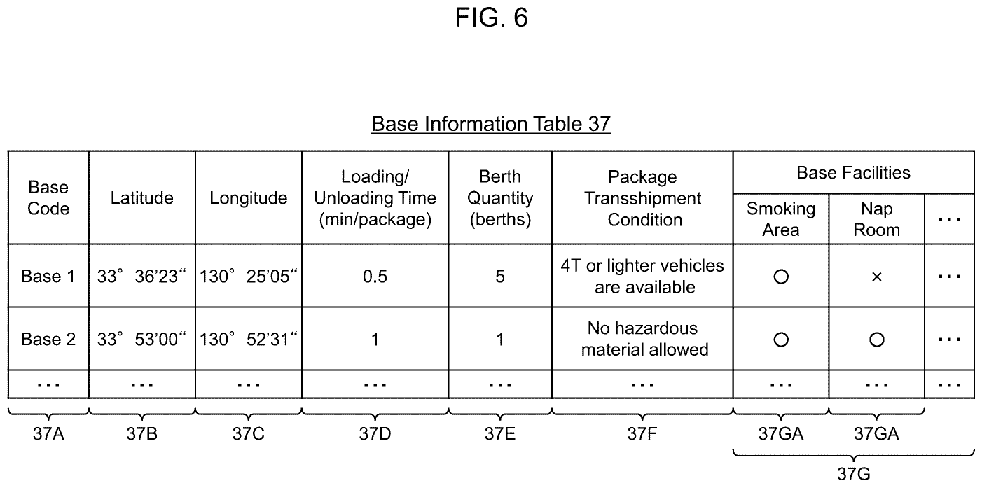

The base information table 37 is a table for managing information about each base (hereinafter referred to as “base information) and is configured by including, as illustrated in FIG. 6, a base name column 37A, a latitude column 37B, a longitude column 37C, a loading/unloading time column 37D, a berth quantity column 37E, a package transshipment condition column 37F, and a base facilities column 37G. In the base information table 37, one record corresponds to one base.

Then, the base name column 37A stores the base name of the relevant base; and the latitude column 37B and the longitude column 37C stores the latitude and the longitude of the base, respectively. Moreover, the loading/unloading time column 37D stores an amount of time required to load or unload one package at the base (hereinafter referred to as “loading/unloading time”). This loading/unloading time changes based on working abilities of registered workers and whether equipment such as shooters exists or not and, for example, an average amount of time until then at the relevant base is registered.

Furthermore, the berth quantity column 37E stores the quantity of berths provided at the relevant base; and the package transshipment condition column 37F stores a condition for the packages and the transportation vehicle regarding which the transshipment can be performed at the relevant base (hereinafter referred to as a “package transshipment condition”). Examples of the above-mentioned package transshipment condition include “4 t or lighter vehicles are available” indicating that only vehicles which weigh 4 t or lighter can perform transshipment of the packages, and “no hazardous material allowed” to prohibit transshipment of hazardous materials.

Furthermore, the base facilities column 37G is divided into a plurality of facility columns 37GA respectively corresponding to representative facilities such as a smoking area and a nap rom which can be set at the base; and each of these facility columns 37GA stores information indicating whether the base is equipped with the relevant facility or not (in FIG. 6, “o” is stored when the base is equipped with the relevant facility; and “x” is stored when the base is not equipped with that facility).

Accordingly, in the case of an example in FIG. 6, it is shown that the base to which the base name “Base 1” is assigned exists at the location where the latitude is “33° 36′23″” and the longitude is “130° 25′05″,” the loading/unloading time per package is “0.5” minutes, the base has “5” berths, and the condition requiring “4 t or lighter vehicles are available” is set as the package transshipment condition. Moreover, FIG. 6 also shows that the “smoking area” is set at the base, but no “nap room” is set.

Incidentally, instead of the loading/unloading time, the base information table 37 may be designed so that it can store the loading time of one package and the unloading time of one package, respectively, as the base information.

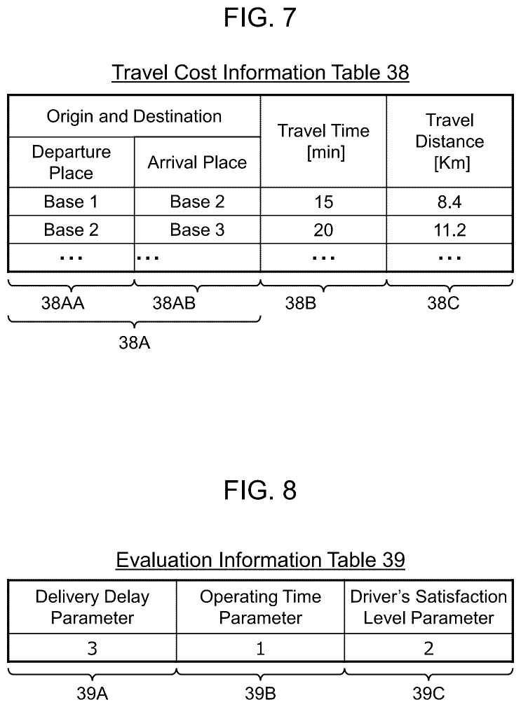

The travel cost information table 38 is a table for managing the time required to travel between two bases and the distance between the two bases. A path from a certain base to another base will be hereinafter referred to as a “route.” The travel cost information table 38 is configured by including, as illustrated in FIG. 7, an origin-and-destination column 38A, a travel time column 38B, and a travel distance column 38C. In the travel cost information table 38, one record corresponds to one route.

Then, the origin-and-destination column 38A is divided into a departure place column 38AA and an arrival place column 38AB; the departure place column 38AA stores the base name of a base which is a departure place of the relevant route; and the arrival place column 38AB stores the base name of a base which is an arrival place of that route. Moreover, the travel time column 38B stores the amount of time required to travel from the base which is the departure place of the relevant route, to the base which is the arrival place; and the travel distance column 38C stores the distance of that route. Accordingly, in the case of an example in FIG. 7, it is shown that the amount of time that is “15 minutes” is required to travel from “Base 1” to “Base 2” and the distance between them is “8.4 km.”

The evaluation information table 39 is a table used to manage preset values of respective parameters which are used when comprehensively evaluating the proposed relay transportation plan created as described earlier from three points of view, i.e., the “Delivery Delay,” the “Operating Time,” and the “Driver's Satisfaction Level.” The evaluation information table 39 is configured by including, as illustrated in FIG. 8, a delivery delay parameter column 39A, an operating time parameter column 39B, and a driver's satisfaction level parameter column 39C.

Then, the delivery delay parameter column 39A stores a delivery delay parameter indicating a degree of influence caused by the delivery delay on a logistics cost; and the operating time parameter column 39B stores an operating time parameter indicating a degree of influence caused by the operating time of the transportation vehicle on the logistics cost. Moreover, the driver's satisfaction level parameter column 39C stores a driver's satisfaction level parameter indicating a degree of influence caused by the driver's satisfaction level regarding their task on the logistics cost.

Accordingly, in the case of an example in FIG. 8, it is shown that the value of the delivery delay parameter is previously set as “3,” the value of the operating time parameter is previously set as “1,” and the value of the driver's satisfaction level parameter is previously set as “2.”

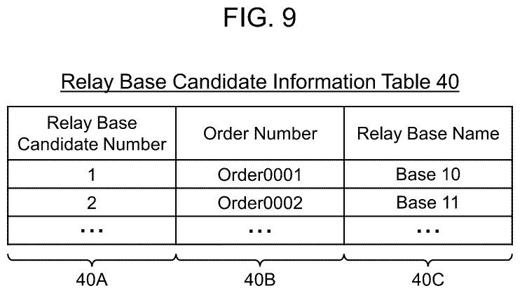

The relay base candidate information table 40 is a table used to manage a relay base candidate(s) for each order, which is decided in the middle of a series of processing based on the aforementioned relay transportation planning function, and is created for each relay base candidate combination. This relay base candidate information table 40 is configured by including, as illustrated in FIG. 9, a relay base candidate number column 40A, an order number column 40B, and a relay base name column 40C. In the relay base candidate information table 40, one record corresponds to one relay base candidate which is decided for one order, and a combination of relay bases for each order registered in this relay base candidate information table 40 is one relay base combination mentioned earlier.

Then, the relay base candidate number column 40A stores a unique identification assigned to a relay base candidate for the relevant order in the relay base candidate information table 40 (a relay base candidate number); and the order number column 40B stores an order number of that order. Moreover, the relay base name column 40C stores the base name of a base which is decided as the relay base candidate for that order.

Accordingly, in the case of an example in FIG. 9, it is shown that a relay base candidate to which the relay base candidate number “1” is assigned is a base to which the base name “Base 10” is assigned and decided for the order, to which the order number “Order0001” is assigned.

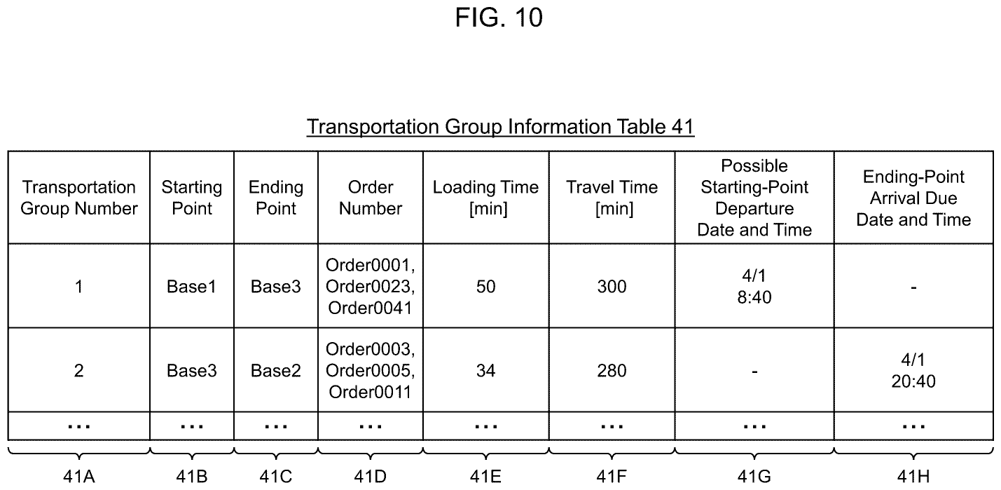

The transportation group information table 41 is a table used to manage transportation groups created in the middle of a sequence of processing based on the relay transportation planning function and is created for each relay base candidate combination. This transportation group information table 41 is configured by including, as illustrated in FIG. 10, a transportation group number column 41A, a starting point column 41B, an ending point column 41C, an order number column 41D, a loading time column 41E, a travel time column 41F, a possible starting-point departure date-and-time column 41G, an ending-point arrival due date-and-time column 41H. In the transportation group information table 41, one record corresponds to one transportation group which is then created.

Then, the transportation group number column 41A stores a unique identification number of the relevant transportation group which is assigned to that transportation group (a transportation group number). Moreover, the starting point column 41B stores the base name of a starting point base in a package route for the relevant transportation group; and the ending point column 41C stores the base name of an ending point base in that package route.

Furthermore, the order number column 41D stores the order number of respective orders which are gathered as the relevant transportation group for any one of package routes; and the loading time column 41E stores predicted task time required to load all the packages belonging to that transportation group onto the transportation vehicle (loading time). Incidentally, the “packages belonging to the transportation group” indicate the respective packages whose package route is formed by gathering transportation objects of the respective orders as the relevant transportation group. The same applies in the following description.

Furthermore, the travel time column 41F stores predicted travel time required for the transportation vehicle to travel from the base whose base name is stored in the starting point column 41B to the base whose base name is stored in the ending point column 41C.

Furthermore, the possible starting-point departure date-and-time column 41G stores the earliest predicted date and time when the transportation vehicle will finish loading all the packages belonging to the relevant transportation group at the base whose base name is stored in the starting point column 41B, and will be able to depart (hereinafter referred to as a “possible starting-point departure date and time”).

Furthermore, the ending-point arrival due date-and-time column 41H stores the latest date and time when the transportation vehicle should arrive at the base whose base name is stored in the ending point column 41C in order to transport the respective packages belonging to the relevant transportation group without delay (hereinafter referred to as an “ending-point arrival due date and time”).

Incidentally, if the package route from the base stored in the starting point column 41B for the transportation group to the base stored in the ending point column 41C corresponds to a package route from the pickup location base of each package belonging to that transportation group to the relay base candidate, the ending-point arrival due date-and-time column 41H does not store the ending-point arrival due date and time. Moreover, if the package route from the base stored in the starting point column 41B for the transportation group to the base stored in the ending point column 41C corresponds to a package route from the relay base candidate of each package belonging to that transportation group to the delivery destination base, the possible starting-point departure date-and-time column 41G does not store the possible starting-point departure date and time.

Accordingly, in the case of an example in FIG. 10, it is shown that packages of each order, to which the order number “Order0001,” “Oder0023,” or “Order0041” is assigned, and which are transported via a package route with “Base 1” as its starting point and “Base 3” as its ending point belong to the transportation group to which the transportation group number “1” is assigned.

Moreover, FIG. 10 also shows that the loading time at the starting point for this transportation group is “50 (minutes)” and the travel time from the starting point to the ending point is predicted as “300 (minutes).” Furthermore, FIG. 10 also shows that the package route from the starting point to the ending point for this transportation group corresponds to a package route from the pickup location base to the relay base candidate for each package (where the ending-point arrival due date and time is “-”), and the possible starting-point departure date and time of this transportation group is “4/1 8:40” (which means “8:40 on April 1st”)

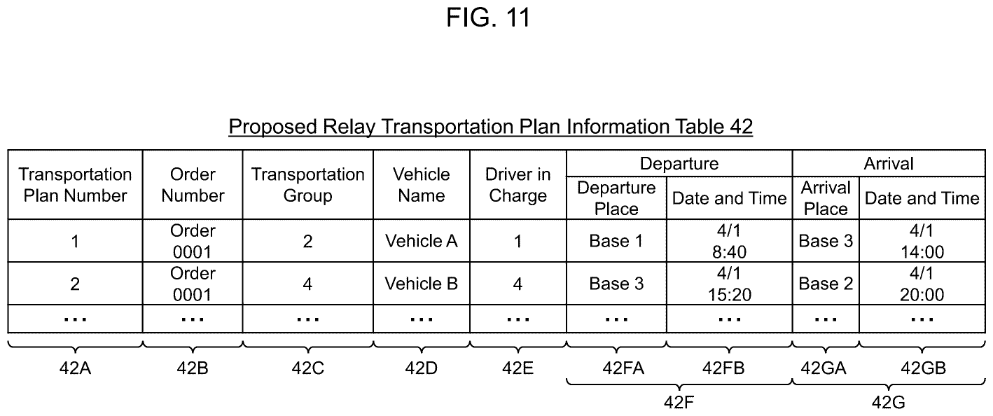

The proposed relay transportation plan information table 42 is a table used to manage a proposed relay transportation plan(s) created in the middle of a sequence of processing based on the relay transportation planning function and is created for each relay base candidate combination. This proposed relay transportation plan information table 42 is configured by including, as illustrated in FIG. 11, a transportation plan number column 42A, an order number column 42B, a transportation group column 42C, a vehicle name column 42D, a driver-in-charge column 42E, a departure column 42F, and an arrival column 42G. In the proposed relay transportation plan information table 42, one record corresponds to one transportation plan created for one package route for the relevant proposed relay transportation plan. The proposed relay transportation plan is an aggregate of transport plans for all of these package routes.

Then, the transportation plan number column 42A stores a unique identification number of the relevant transportation plan which is assigned to that transportation plan in the proposed relay transportation plan information table 42 (a transportation plan number). Moreover, the order number column 42B stores the order number of the relevant order; and the transportation group column 42C stores a transportation group number of a transportation group to which the relevant package route belongs.

Furthermore, the vehicle name column 42D stores a vehicle name of a transportation vehicle allocated to the relevant transportation group; and the driver-in-charge column 42E stores a driver number of a driver who is allocated to that transportation group (and drives the transportation vehicle allocated to that transportation group).

Furthermore, the departure column 42F is divided into a departure place column 42FA and a date-and-time column 42FB; and regarding the relevant transportation plan, the base name of a base which is a departure place of packages for the relevant order is stored in the departure place column 42FA and the date and time when the packages should depart from that base is stored in the date-and-time column 42FB.

Similarly, the arrival column 42G is divided into an arrival place column 42GA and a date-and-time column 42GB; and regarding the relevant transportation plan, the base name of a base which is an arrival place of the packages for the relevant order is stored in the arrival place column 42GA and the date and time when the packages should arrive at that base is stored in the date-and-time column 42GB.

Accordingly, in the case of an example in FIG. 11, it is shown that regarding a transportation plan to which the transportation plan number “1” is assigned, the packages for an order to which the order number “Order 0001” is assigned are sorted to a transportation group to which the transportation group number “2” is assigned, and a transportation vehicle to which the vehicle name “Vehicle A” is assigned and a driver to whom the driver number “1” is assigned are allocated to that transportation group.

Moreover, FIG. 11 shows that the relevant transportation plan is a plan designed so that the transportation vehicle on which the packages of the relevant transportation group are loaded will depart from the base with the base name “Base 1” at “4/1 8:00” (which means “8:00 on April 1st”) and arrive at the base with the base name “Base 3” at “4/1 14:00” (which means “14:00 on April 1st”)

Incidentally, information of the “quantity” indicating the total number of transportation object packages for each transportation plan, the “weight” indicating the total weight of the packages, the “volume” indicating the total volume of the packages, or a partial combination of the “quantity,” the “weight,” and the “volume,” or the “package amount indicating the package amount may be added as information of each transportation plan for the proposed relay transportation plan.

Meanwhile, the relay base candidate creation unit 30 (FIG. 2) is a functional unit having a function that decides the aforementioned relay base candidate for each order. The transportation route of the packages for each order is divided into two package routes by this relay base candidate. The relay base candidate creation unit 30 registers each created relay base candidate for each order in the relay base candidate information table 40 (FIG. 9).

Moreover, the transportation group creation unit 31 (FIG. 1) is a functional unit that creates the aforementioned transportation group based on the decided result of the relay base candidate creation unit 30. The transportation group creation unit 31 registers each created transportation group in the transportation group information table 41 (FIG. 10).

Furthermore, the proposed relay transportation plan creation unit 32 (FIG. 1) is a functional unit having a function that creates a transportation plan for each package route by allocating a transportation vehicle and a driver to each transportation group created by the transportation group creation unit 31. The proposed relay transportation plan creation unit 32 registers each created transportation plan for each package route in the proposed relay transportation plan information table 42 (FIG. 11).

Furthermore, the proposed relay transportation plan evaluation unit 33 (FIG. 1) is a functional unit having a function that evaluates the proposed relay transportation plans created by the proposed relay transportation plan creation unit 32. The proposed relay transportation plan evaluation unit 33 outputs a proposed relay transportation plan with the highest evaluation value, as a relay transportation plan which is created at that time, among the proposed relay transportation plans which are created by the proposed relay transportation plan creation unit 32.

Specific processing content of the relay base candidate creation unit 30, the transportation group creation unit 31, the proposed relay transportation plan creation unit 32, and the proposed relay transportation plan evaluation unit 33 will be described later.

### (1-3) Various Kinds of Processing Regarding Relay Transportation Planning Function

Next, an explanation will be provided about the processing content of various kinds of processing executed by the relay transportation planning apparatus 2 in relation to the above-mentioned relay transportation planning function. The following explanation will be given by referring to the relay base candidate creation unit 30, the transportation group creation unit 31, the proposed relay transportation plan creation unit 32, or the proposed relay transportation plan evaluation unit 33 as a processing subject of each processing; however, needless to say, the CPU 10 for the relay transportation planning apparatus 2 described earlier with reference to FIG. 1 actually executes the processing according to the relevant program which is read from the auxiliary storage apparatus 13 to the RAM 11.

### (1-3-1) Relay Transportation Plan Devising Processing

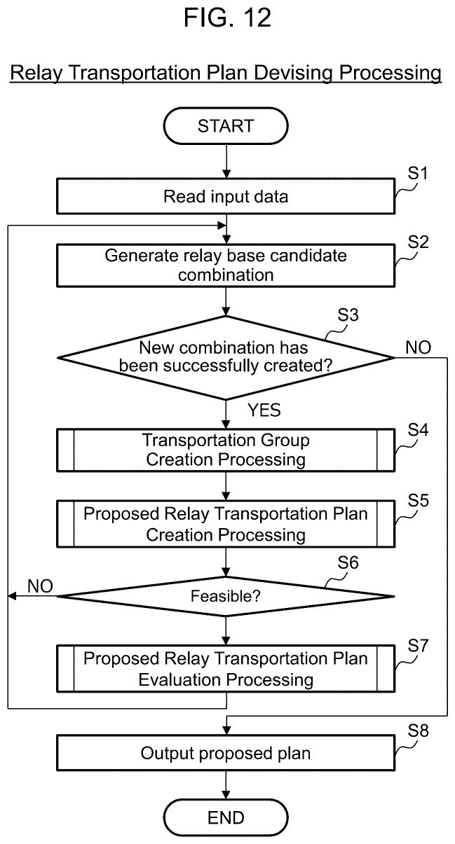

FIG. 12 illustrates a flow of a series of processing executed by the relay transportation planning apparatus 2 when the user inputs an instruction to devise a relay transportation plan by a specified operation (hereinafter referred to as a “relay transportation plan devising instruction”) to the relay transportation planning apparatus 2 and the input unit 22 (FIG. 2) accepts the relay transportation plan devising instruction (hereinafter referred to as “relay transportation plan devising processing”).

When the input unit 22 accepts the relay transportation plan devising instruction, the relay base candidate creation unit 30 firstly reads the aforementioned package information, vehicle information, driver information, base information, travel cost information, and evaluation information, which are input to a portable storage medium, via the media reading device 16 (FIG. 1) and stores these pieces of information in the relevant tables, that is, the package information table 34 (FIG. 3), the vehicle information table 35 (FIG. 43), the driver information table 36 (FIG. 5), the base information table 37 (FIG. 6), the travel cost information table 38 (FIG. 7), or the evaluation information table 39 (FIG. 8), respectively (S1).

However, these pieces of the package information, the vehicle information, the driver information, the base information, the travel cost information, and the evaluation information are distributed to and retained by the driver terminal(s) 4, the vehicle terminal(s) 5, and the base plan management terminal(s) 6 described earlier with reference to FIG. 1 and the relay base candidate creation unit 30 may acquire these pieces of information from the driver terminal(s) 4, the vehicle terminal(s) 5, and the base plan management terminal(s) 6 via the network 3 (FIG. 1).

Subsequently, the relay base candidate creation unit 30 generates one relay base candidate combination which is a combination of decided relay base candidates for each order by deciding the respective relay base candidates for packages for each order on the basis of the package information stored in the package information table 34 and the base information stored in the base information table 37 (S2).

Under this circumstance, the relay base candidate creation unit 30 decides each relay base candidate for each order in order to make it possible to generate a relay base candidate combination regarding which a total of the travel time between the pickup location base and the relay base and the travel time between the relay base and the delivery destination base is short and which is different from relay base candidate combinations that have ever been created. Then, the relay base candidate creation unit 30 stores each of the decided relay base candidates for each order in the relay base candidate information table 40 (FIG. 9).

Next, the relay base candidate creation unit 30 judges whether or not a new relay base candidate combination which had never been created so far has been successfully created in step S2 (S3). This judgment can be performed by comparing the information stored in each relay base candidate information table 40, which is created for each relay base candidate combination that had been created so far, with the content of the relay base candidate combination which has been created this time. Then, if the relay base candidate creation unit 30 obtains an affirmative result in this judgment, it invokes the transportation group creation unit 31.

When the transportation group creation unit 31 is invoked by the relay base candidate creation unit 30, it creates all the transportation groups that can be created based on, for example, the relay base candidates for the respective orders, which are stored in the relay base candidate information table 40, and the package information stored in the package information table 34 and creates the transportation group information table 41 which store necessary information about the respective generated transportation groups (S4). Then, the transportation group creation unit 31 invokes the proposed relay transportation plan creation unit 32.

When the proposed relay transportation plan creation unit 32 is invoked by the transportation group creation unit 31, it allocates a transportation vehicle and a driver to each transportation group registered in the transportation group information table 41. Moreover, the proposed relay transportation plan creation unit 32 creates each transportation plan for each transportation group by deciding departure places and departure dates and times, and arrival places and arrival dates and times of the packages belonging to these transportation groups. Consequently, a proposed relay transportation plan which is an aggregate of the transportation plans for each of these respective transportation groups is created. Then, the proposed relay transportation plan creation unit 32 registers necessary information about the transportation plans for each created transportation group in the proposed relay transportation plan information table 42 (S5).

Subsequently, the proposed relay transportation plan creation unit 32 judges whether the proposed relay transportation plan created as described above is feasible or not (S6). This judgment is performed by judging whether or not transportation vehicles and drivers are allocated to all the transportation groups and judging whether or not any transportation plan is not designed so that the transportation vehicle on which packages of each transportation group will depart from a certain relay base before the packages arrive at the relay base.

Then, if the proposed relay transportation plan creation unit 32 obtains a negative result in this judgment, it returns to step S2 and invokes the relay base candidate creation unit 30. As a result, the relay base candidate creation unit 30 generates a new relay base candidate combination by changing the decided content of the relay base candidates for some or all the orders (S2). Consequently, the processing in and after step S3 is then executed in the same manner as described earlier.

On the other hand, if the proposed relay transportation plan creation unit 32 obtains an affirmative result in the judgment of step S6, it invokes the proposed relay transportation plan evaluation unit 33. Then, the proposed relay transportation plan evaluation unit 33 invoked by the proposed relay transportation plan creation unit 32 comprehensively evaluate the proposed relay transportation plan composed of transportation plans for each transportation group, which is then registered in the proposed relay transportation plan information table 42, from three points of view, that is, a “Delivery Delay,” the “Operating Time of Transportation Vehicle,” and the “Driver's Satisfaction Level” (S7).

Moreover, the proposed relay transportation plan evaluation unit 33 judges whether or not the latest evaluation result is better than any one of the proposed relay transportation plans which have ever been evaluated; and if the proposed relay transportation plan evaluation unit 33 obtains an affirmative result, it stores the evaluation value of the latest proposed relay transportation plan as a tentative solution and then returns to step S2 and invokes the relay base candidate creation unit 30 again. Moreover, if the proposed relay transportation plan evaluation unit 33 obtains a negative result in that judgment, it immediately returns to step S2 and invokes the relay base candidate creation unit 30.

Then, the relay base candidate creation unit 30 invoked by the proposed relay transportation plan evaluation unit 33 generates a new relay base candidate combination by changing the decided content of the relay base candidates for some or all the orders (S2). Consequently, the processing in and after step S3 is then executed in the same manner as described earlier.

If the relay base candidate creation unit 30 eventually obtains a negative result in step S3 by finishing executing the processing of step S3 to step S7 with respect to all the relay base candidate combinations which can be thought of as relay base candidate combinations of the respective transportation groups, the relay base candidate creation unit 30 outputs necessary information based on the proposed relay transportation plan, whose evaluation value is then stored, to the display unit 23 (FIG. 2) for the relay transportation planning apparatus 2 and transmits it to the relevant driver terminal(s) 4, the vehicle terminal(s) 5, and the base plan management terminal(s) 6, respectively (S8).

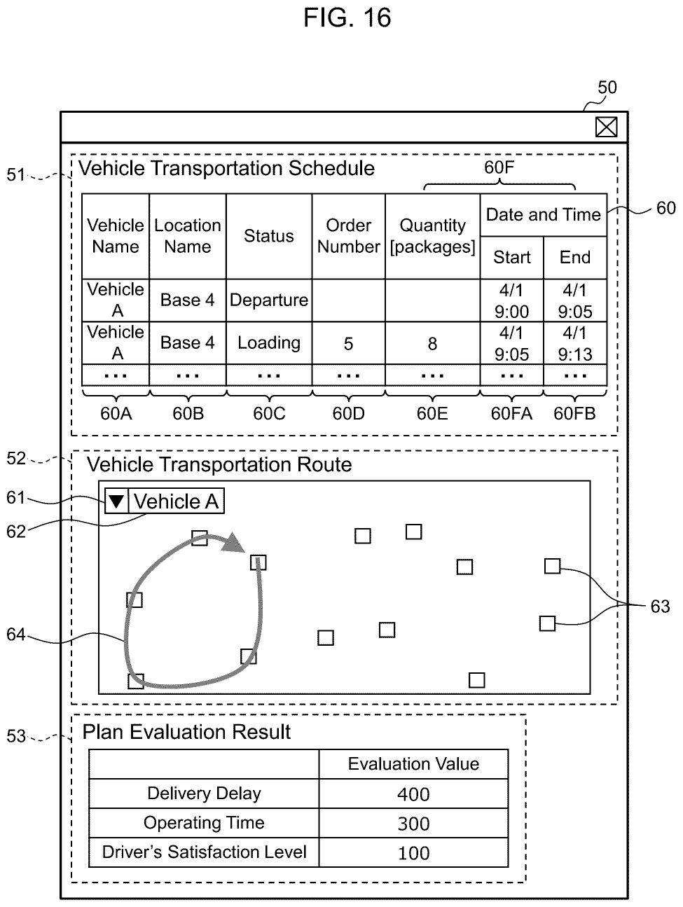

Consequently, various kinds of screens which will be described later with reference to FIG. 16 to FIG. 19 are displayed on the driver terminal(s) 4, the vehicle terminal(s) 5, and the base plan management terminal(s) 6, respectively. As a result, the series of processing by the relay transportation planning apparatus 2 terminates.

### (1-3-2) Transportation Group Creation Processing

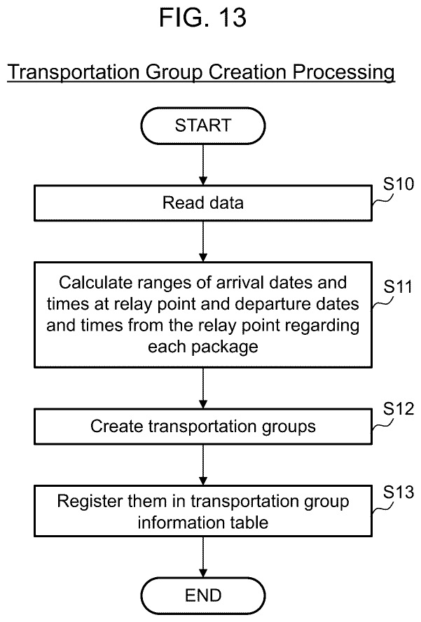

FIG. 13 illustrates specific content of a series of processing executed by the transportation group creation unit 31 in step S4 of the relay transportation plan devising processing described above with reference to FIG. 12 (hereinafter referred to as “transportation group creation processing”).

When the transportation group creation unit 31 is invoked by the relay base candidate creation unit 30 which has finished the processing in step S3 of the relay transportation plan devising processing, it starts the transportation group creation processing illustrated in this FIG. 13. Then, the transportation group creation unit 31 firstly reads the package information, the base information, the travel cost information, and the relay base candidate information, respectively, which are stored in the package information table 34, the base information table 37, the travel cost information table 38, and the relay base candidate information table 40, respectively (S10).

Then, the transportation group creation unit 31 executes processing in step S11 to step S13 on each order number as a target which is included in the package information. Incidentally, an explanation will be provided below about a case where only one relay base is created for the order.

Practically, the transportation group creation unit 31 calculates a range of dates and times when packages of each order should arrive at the relay base, and a range of dates and times when these packages should depart from that relay base, respectively (S11).

Specifically, the transportation group creation unit 31 searches for the relay base candidate information with respect to each order number of the package information, respectively, and identifies the base name of each relevant relay base. Moreover, the transportation group creation unit 31 acquires the travel time of the relevant route, with respect to each order number, by recognizing a pickup location code of the package information as the departure place and its relay base as the arrival place.

Furthermore, the transportation group creation unit 31 acquires, with respect to each order number, the range of pickup dates and times of packages corresponding to the relevant order number (the starting date and time and the ending date and time) from the package information and calculates the range of dates and times when the relevant packages should arrive at the relay base, by adding the travel time acquired as described above to the starting date and time and the ending date and time of the obtained pickup dates and times, respectively.

Moreover, the transportation group creation unit 31 acquires, with respect to each order number, the travel time of the relevant route from the travel cost information by recognizing the relevant relay base as the departure place and the delivery destination of the relevant package as the arrival place. Then, the transportation group creation unit 31 acquires the range of delivery dates and times of the relevant packages (the starting date and time and the ending date and time) from the package information with respect to each order number and calculates the ranges of dates and times when the relevant packages should depart from the relay base, by subtracting the travel time acquired as described above from the starting date and time and the ending date and time of the acquired delivery dates and times, respectively.

Subsequently, the transportation group creation unit 31 creates a transportation group based on the range of dates and times when the packages of each order should arrive at the relay base, and the range of dates and times when these packages should depart from the relay base, as calculated in step S11 (S12).

Specifically, the transportation group creation unit 31 divides the relevant package route, with respect to each order number, into a package route regarding which the pickup location of the packages is a starting point and the relevant relay base is an ending point, and a package route regarding which that relay base is a starting point and the delivery destination is an ending point. Then, the transportation group creation unit extracts each of the package routes whose starting points and ending points match each other, as the same package route group from among the respective package routes which are obtained as described above with respect to each order number.

Then, regarding each extracted same package route group, if each package route belonging to the same package route group is a package route from the pickup location base of the relevant packages to a base which is the relay base, the transportation group creation unit 31 forms a transportation group by gathering the package routes regarding which both the range of the pickup dates and times of the relevant packages and the range of the dates and times when the packages should arrive at the relay base at least partly overlap with each other, into the same group. Accordingly, when each package route belonging to the same package route group is a package route from the pickup location base of the relevant packages to the base which is the relay base, two or more transportation groups can sometimes be formed from one same package route group.

Moreover, regarding each extracted same package route group, if each package route belonging to the same package route group is a package route from the base which is the relay base of the relevant packages to the delivery destination base, the transportation group creation unit 31 gathers the package routes regarding which both the range of the dates and times when the relevant packages should depart from the relay base and the time range of the delivery dates and times to the delivery destination base at least partly overlap with each other, into the same transportation group. Accordingly, also when each package route belonging to the same package route group is a package route from the base which is the relay base of the relevant packages to the delivery destination base, two or more transportation groups can sometimes be formed from one same package route group.

Incidentally, no violation of the package transportation conditions may be set as a condition for gathering and forming the packages for each order into the same transportation group.

Moreover, when forming a transportation group, an upper limit for a total quantity of packages to be gathered and formed into one transportation group may be set in advance in consideration of a restriction on the number of transportation vehicles which can be platooned at the same time or a restriction on the number of towed vehicle which can be towed at the same time, and the transportation group creation unit 31 may form the transportation group so that the total quantity of packages belonging to one transportation group will become equal to or less than the above-mentioned upper limit.

Furthermore, for example, the transportation group creation unit 31 may form a transportation group so that, for example, a deviation of the weight of packages to be loaded onto the respective transportation vehicles to be platooned at the same time or the respective towed vehicles to be towed at the same time will be equal to or less than a constant value, in consideration of a restriction regarding the respective transportation vehicles to be platooned or the packages loaded onto a plurality of transportation vehicles which can be platooned at the same time, or a restriction regarding packages loaded onto towed vehicles which can be towed at the same time by the transportation vehicle.

Furthermore, the transportation group creation unit 31 may manage transportation vehicles of the kinds required at each base at a specified timing in the future (for example, at starting time of each base in the next morning) and form a transportation group so that each of the transportation vehicles required at each base will arrive at each base no later than the above-specified timing, and each of the transportation vehicles required at each base will have transported the packages so as to be in an available state at the relevant base and will be present at each base at that timing.

Subsequently, the transportation group creation unit 31 stores necessary information about all the transportation groups formed as described above in the transportation group information table 41 (FIG. 10) and registers these transportation groups in the transportation group information table (S13). Then, the transportation group creation unit 31 terminates this transportation group creation processing and invokes the proposed relay transportation plan creation unit 32.

### (1-3-3) Proposed Relay Transportation Plan Creation Processing

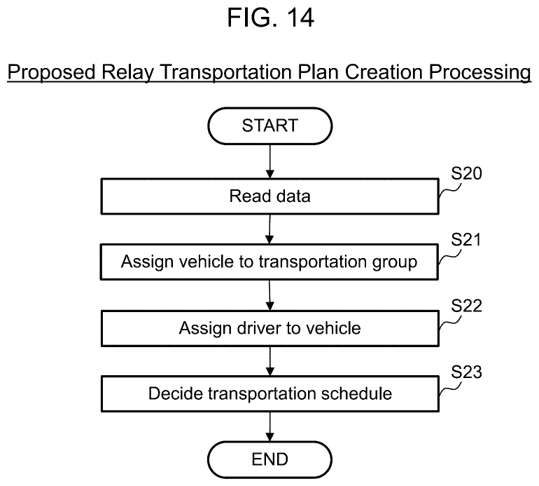

Meanwhile, FIG. 14 illustrates specific content of a series of processing executed by the proposed relay transportation plan creation unit 32 in step S5 of the relay transportation plan devising processing described earlier with to FIG. 12 (hereinafter referred to as “proposed relay transportation plan creation processing”).

When the proposed relay transportation plan creation unit 32 is invoked by the transportation group creation unit 31 which has finished the transportation group creation processing (FIG. 13), it starts the proposed relay transportation plan creation processing illustrated in this FIG. 14. Then, the proposed relay transportation plan creation unit 32 firstly reads each of the vehicle information, the driver information, the base information, the travel cost information, and the transportation group information which are stored in the vehicle information table 35, the driver information table 36, the base information table 37, the travel cost information table 38, and the transportation group information table 41, respectively (S20).

Subsequently, the proposed relay transportation plan creation unit 32 allocates a transportation vehicle to each transportation group (S21).

Specifically, the proposed relay transportation plan creation unit 32 selects one transportation group from among the transportation groups registered in the transportation group information table 41 and acquires the order numbers of all the orders whose package routes belong to the selected transportation group (hereinafter referred to as a “first selected transportation group”) from the transportation group information. Moreover, the proposed relay transportation plan creation unit 32 acquires the quantity of transportation object packages for the orders with the respective acquired order numbers from the package information, and calculates a total value of these acquired quantities of the packages.

Moreover, the proposed relay transportation plan creation unit 32 extracts a transportation vehicle, which can load all the packages belonging to the first selected transportation group and satisfies the transportation conditions for each package, by referring to the vehicle information and the package information and allocates that transportation vehicle to the selected transportation group.

Under this circumstance, if the proposed relay transportation plan creation unit 32 fails to extract a transportation vehicle whose upper limit loaded quantity is larger than a total quantity of packages belonging to the first selected transportation group, from among the transportation vehicles which satisfy the transportation conditions for each package belonging to the first selected transportation group, the proposed relay transportation plan creation unit 32 extracts a plurality of transportation vehicles which respectively satisfy the transportation conditions of these packages so that a total value of the upper limit loaded quantities exceeds a total value of the packages belonging to the first selected transportation group, and then allocates the transportation vehicles to the first selected transportation group.

Moreover, under this circumstance, the proposed relay transportation plan creation unit 32 may allocate a plurality of transportation vehicles which can be platooned or a towing vehicle (tractor) for towing at least two or more towed vehicles (trailers) to the transportation group as necessary.

For example, if a package amount of packages which are addressed to a specified delivery destination base and will arrive at a relay base within a specified amount of time is larger than the package amount of packages which can be transported by one transportation vehicle, transportation efficiency can be enhanced and transportation cost can be reduced by allocating the plurality of transportation vehicles which can be platooned or the towing vehicle for towing at least two or more towed vehicles as the transportation vehicle(s) from the relay base to the delivery destination base as described above.

Moreover, if the quantity of transportation vehicles which will transport packages addressed to the specified delivery destination base within a specified amount of time is larger than the quantity of transportation vehicles which should depart from that relay base to the delivery destination base within that amount of time, the transportation efficiency can be also enhanced and the transportation cost can be reduced by allocating the plurality of transportation vehicles which can be platooned or the towing vehicle for towing at least two or more towed vehicles as the transportation vehicle(s) from the relay base to the delivery destination base as described above.

Furthermore, if there are not less than a specified quantity of packages which share a common package route within a specified amount of time (for example, not less than a package amount which can be transported by one transportation vehicle for the transportation), similar effects can be obtained by allocating the plurality of transportation vehicles which can be platooned or the towing vehicle for towing at least two or more towed vehicles, as the transportation vehicle(s) from the relay base to the delivery destination base, to the transportation group for which the packages are transported via the relevant package route within that amount of time.

Furthermore, the transportation vehicles may be allocated to the transportation group so that the transportation vehicles of the kinds required at the respective bases at a specified timing in the future (for example, the starting time of each base in the next morning) will be present at these respective bases.

Incidentally, regarding the vehicle information, if an upper limit load capacity of each transportation vehicle is defined by not quantity, but by weight or volume, a plurality of transportation vehicles which satisfy the transportation conditions of these packages are extracted and allocated to the first selected transportation group so that a total value of the upper limit weight or volume exceeds a total value of the weight or volume of all the packages belonging to the selected transportation group.

Then, the proposed relay transportation plan creation unit 32 executes the above-described processing on all the transportation groups registered in the transportation group information table 41 and thereby allocates the transportation vehicles to these transportation groups.

Next, the proposed relay transportation plan creation unit 32 allocates a driver to each transportation vehicle allocated to each transportation group (S22).

Specifically, the proposed relay transportation plan creation unit 32 selects one transportation group from among the transportation groups registered in the transportation group information table 41 and identifies the quantity of transportation vehicles allocated to the selected transportation group (hereinafter referred to as a “second selected transportation group”) in step S21. Moreover, the proposed relay transportation plan creation unit 32 calculates the number of drivers required for the second selected transportation group by dividing the identified quantity of the transportation vehicles by the maximum number of vehicles which can be platooned and rounding up a faction of a quotient.

Moreover, the proposed relay transportation plan creation unit 32 acquires each travel time from the relevant driver's place of affiliation to a starting point of the second selected transportation group (hereinafter referred to as “first travel time”) from the travel cost information based on the driver information with respect to each driver registered in the driver information table 36. Similarly, the proposed relay transportation plan creation unit 32 acquires each travel time from the base which is the relevant driver's place of affiliation to an ending point of the second selected transportation group (hereinafter referred to as “second travel time”) from the travel cost information based on the driver information with respect to each driver registered in the driver information table 36.

Then, the proposed relay transportation plan creation unit 32 sets, regarding each driver, a shorter travel time of either the first travel time or the second travel time acquired as described above as that driver's evaluation value and a necessary number of drivers including the driver with the smallest evaluation value to the second selected transportation group.

Under this circumstance, when a specified qualification or the like is required to, for example, transport packages belonging to the second selected transportation group, the proposed relay transportation plan creation unit 32 refers to the driver information and allocates a necessary number of drivers whose evaluation values are as small as possible, from among the drivers who possess that required qualification or the like, to the second selected transportation group. Moreover, under this circumstance, the proposed relay transportation plan creation unit 32 may allocate the drivers to the second selected transportation group also in consideration of each driver's personal preferences by referring to the driver information.

Incidentally, a maximum of two transportation groups, that is, a transportation group regarding which a certain first base is its starting point and another second base is its ending point and a transportation group regarding which the second base is its starting point and the first base is its ending point can be allocated to each driver. Under this circumstance, these two transportation groups may be allocated only when a labor condition specifying that a total of the relevant driver's travel time regarding the two transportation groups allocated to that driver is equal to or less than the driver's operating time is satisfied.

When only a transportation group regarding which the relay base is its starting point or ending point is allocated to the driver, the means of transport from the driver's place of affiliation, to which no transportation group is allocated, to the relevant relay base or from that relay base to the driver's place of affiliation is decided as a means of transport desired by that driver to be included in the driver information.

Subsequently, the proposed relay transportation plan creation unit 32 decides respective schedules for each transportation group, each transportation vehicle allocated to each of these transportation groups, and each driver allocated to these transportation vehicles. (S23).

Specifically, the proposed relay transportation plan creation unit 32 identifies, with respect to each transportation group, the earliest date and time when the relevant transportation group can depart from their starting point (hereinafter referred to as a “possible departure date and time”).

For example, if the starting point of the relevant transportation group is a pickup location base of each package belonging to that transportation group, the proposed relay transportation plan creation unit 32 identifies the latest ending date and time of the pickup date and time of these packages as the possible departure date and time by referring to the package information. Moreover, if the ending point of the relevant transportation group is the relay base, the proposed relay transportation plan creation unit 32 calculates the range of the possible departure dates and times when each package belonging to that transportation group can depart from the relay base in the same manner as in step S11 of the transportation group creation processing as described earlier with reference to FIG. 13 and identifies the latest date and time within the calculated time range as the possible departure date and time. Then, the proposed relay transportation plan creation unit 32 decides the thus-identified possible departure date and time as a provisional departure date and time from the starting point of the relevant transportation group.

Moreover, the proposed relay transportation plan creation unit 32 extracts, with respect to each transportation group, the travel time from the starting point of the relevant transportation group to their ending point from the travel cost information and sets a date and time obtained by adding the extracted travel time to the above-described provisional departure date and time, as the date and time when each package belonging to that transportation group will arrive at the ending point of that transportation group (hereinafter referred to as a “scheduled arrival date and time”).

Then, the proposed relay transportation plan creation unit 32 adds a schedule with respect to each transportation group to depart from the starting point of the relevant transportation group at the above-mentioned possible departure date and time and arrive at the ending point of that transportation group at the above-mentioned scheduled arrival date and time to a transportation schedule of the transportation vehicle allocated to that transportation group.

Moreover, regarding each driver allocated to these transportation groups, if the driver is allocated only to the relevant transportation group, the proposed relay transportation plan creation unit 32 adds a travel schedule from the driver's place of affiliation to a relay base which is the ending point of that transportation group or from a relay base which is the starting point of that transportation group to the driver's place of affiliation to the driver's transportation schedule.

As a result of the above-described processing, the transportation schedules of each transportation group, each transportation vehicle allocated to each of these transportation groups, and each driver allocated to each of these transportation vehicles are decided. Then, the proposed relay transportation plan creation unit 32 terminates this proposed relay transportation plan creation processing.

### (1-3-4) Proposed Relay Transportation Plan Evaluation Processing

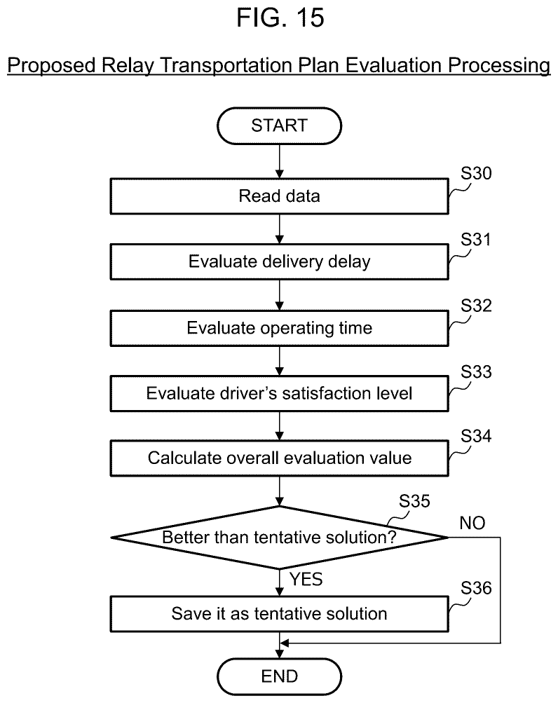

On the other hand, FIG. 15 illustrates specific content of a series of processing executed by the proposed relay transportation plan evaluation unit 33 in step S5 of the relay transportation plan devising processing described earlier with reference to FIG. 12 (hereinafter referred to as “proposed relay transportation plan evaluation processing”).

When the proposed relay transportation plan evaluation unit 33 proceeds to step S5 of the relay transportation plan devising processing, it starts the proposed relay transportation plan evaluation processing illustrated in this FIG. 15 and firstly read necessary information from the respective tables retained by the storage unit 21 (FIG. 2) (S30).

Specifically, the proposed relay transportation plan evaluation unit 33 reads the package information, the vehicle information, the driver information, or the base information from the package information table 34, the vehicle information table 35, the driver information table 36, and the base information table 37, respectively. Moreover, the proposed relay transportation plan evaluation unit 33 reads the respective values of the delivery delay parameter, the operating time parameter, and the driver's satisfaction level parameter, respectively, from the evaluation information table 39. Furthermore, the proposed relay transportation plan evaluation unit 33 reads a proposed relay transportation plan (hereinafter referred to as an “evaluation target proposed relay transportation plan”) from the proposed relay transportation plan information table 42.

Subsequently, the proposed relay transportation plan evaluation unit 33 calculates an evaluation value with respect to a delivery delay of each package regarding the evaluation target proposed relay transportation plan (hereinafter referred to as a “Delivery Delay evaluation value”) (S31). The delivery delay evaluation value is calculated by referring to the package information and the proposed relay transportation plan information and adding up a total amount of deviations from a pickup time frame of the respective packages which fail to comply with the pickup time frame according to the evaluation target proposed relay transportation plan, and a total amount of deviations from a delivery time frame of the respective packages which fail to comply with the time frame for the delivery date and time according to the evaluation target proposed relay transportation plan, for example, in accordance with the following expression.

$$[ Math . 1 ]$$

$$Delivery Delay Evaluation Value = \qquad ( 1 )$$

$${Σ}_{Packages Failing To Comply With Pickup Time Frame Restriction}$$

$$( Deviations from Pickup Time Frame ) +$$

$${Σ}_{Packages Failing To Comply With Delivery Time Frame Restriction}$$

$$( Deviations from Delivery Time Frame )$$

Under this circumstance, in Expression (1), the “pickup time frame” means a time range within which the packages decided for each base can be picked up; and the “deviation(s) from the pickup time frame” means a time difference between an ending time of day of the relevant pickup time frame and an ending time of day of a pickup time of day of the relevant package at the base. For example, if regarding a certain base the pickup time frame of that base is from 13:00 to 15:00 and the time range of the pickup date and time for a certain package at that base is from 18:00 to 18:15, an absolute value of the difference between 15:00 and 18:15, i.e., 3 hours and 15 minutes is the “deviation from the pickup time frame.”

Moreover, in Expression (1), the “delivery time frame” means a time range within which packages decided for each base can be delivered; and the “deviation(s) from the delivery time frame” means a time difference between an ending time of day of the delivery time frame and an ending time of day of the delivery date and time of the relevant package at that base.

Next, the proposed relay transportation plan evaluation unit 33 calculates an evaluation value of the operating time of each transportation vehicle for the evaluation target proposed relay transportation plan (S32). The operating time evaluation value is calculated by referring to, for example, the vehicle information, the current status of the vehicles, the proposed relay transportation plan information and calculating a total amount of a time difference between the operating time for the relevant evaluation target proposed relay transportation plan with respect to each transportation vehicle which fails to comply with an upper limit for the operating time predetermined for each transportation vehicle (hereinafter referred to as “upper limit operating time”), and the upper limit operating time of that transportation vehicle according to the evaluation target proposed relay transportation plan in accordance with the following expression.

$$[ Math . 2 ]$$

$$Operating Time Evaluation Value = \qquad ( 2 )$$

$${Σ}_{Vehicle Failing To Comply With Upper Limit Operation Time}$$

$$( Operating Time of Proposed Plan - Upper Limit Operating Time )$$

Furthermore, the proposed relay transportation plan evaluation unit 33 calculates an evaluation value of each driver's satisfaction level regarding the evaluation target proposed relay transportation plan (hereinafter referred to as a “Driver's Satisfaction Level evaluation value”) (S33). The driver's satisfaction level evaluation value is calculated as a percentage of a total value of satisfaction rates regarding the number of the relevant driver's personal preferences with respect to each driver according to the evaluation target proposed relay transportation plan by using, for example, the driver information, the base information, and the proposed relay transportation plan information in accordance with the following expression.

$$[ Math . 3 ]$$

$$Driver ’ s Satisfaction Level Evaluation Value =$$

$${Σ}_{Driver} ( The Number of Satisfied Driver ’ s Personal Preferences /$$

$$The Number of Personal Preferences ) \times 100 \%$$

Then, the proposed relay transportation plan evaluation unit 33 calculates an overall evaluation value based on the delivery delay evaluation value calculated in step S31, the operating time evaluation value calculated in step S32, the driver's satisfaction level evaluation value calculated in step S33, and the evaluation information by adding up the delivery delay evaluation value, the operating time evaluation value, and the driver's satisfaction level evaluation value with weights of a delivery delay evaluation parameter, an operating time evaluation parameter, and a driver's satisfaction level evaluation parameter, respectively, in accordance with the following expression (S34).

$$[ Math . 4 ]$$

$$Overall Evaluation Value = ( Delivery Delay Evaluation Parameter ) \times \qquad ( 4 )$$

$$( Delivery Delay Evaluation Value ) +$$

$$( Operating Time Evaluation Parameter ) \times$$

$$( Operating Time Evaluation Value ) +$$

$$( Driver ’ s Satisfaction Level Evaluation Parameter ) \times$$

$$( Driver ’ s Satisfaction Level Evaluation Value )$$

Subsequently, the proposed relay transportation plan evaluation unit 33 judges whether or not the overall evaluation value calculated in step S34 is larger than the tentative solution saved as the maximum value of overall evaluation values which have been calculated so far (S35).

Then, if the proposed relay transportation plan evaluation unit 33 obtains an affirmative result in this judgment, it saves the proposed relay transportation plan evaluation value obtained this time as the tentative solution (S36) and then terminates this proposed relay transportation plan evaluation processing.

On the other hand, if the proposed relay transportation plan evaluation unit 33 obtains a negative result in the judgment of step S35, it terminates this proposed relay transportation plan evaluation processing without saving the proposed relay transportation plan evaluation value, which has been obtained this time, as the tentative solution.

### (1-4) Configurations of Various Kinds of Display Screens

### (1-4-1) Result Summary Display Screen

FIG. 16 illustrates a structure example of a result summary display screen 50 displayed on the display device 15 (FIG. 1) for the relay transportation planning apparatus 2 based on the processing result of the relay transportation plan devising processing, which is output from the proposed relay transportation plan evaluation unit 33 in step S8 of the relay transportation plan devising processing described earlier with reference to FIG. 12.

This result summary display screen 50 is a screen indicating the processing result of the relay transportation plan devising processing and is configured by including a vehicle transportation schedule display area 51, a vehicle transportation route display area 52, and a plan evaluation result display area 53.

Then, in the vehicle transportation schedule display area 51, the best transportation schedule for packages by each transportation vehicle, which is created by the relay transportation plan devising processing, is displayed in a table format.

Practically, in the vehicle transportation schedule display area 51, a vehicle transportation schedule table 60 including a vehicle name column 60A, a location name column 60B, a status column 60C, an order number column 60D, a quantity column 60E, and a date-and-time column 60F is displayed. In the vehicle transportation schedule table 60, one record corresponds to the status of one task by a certain transportation vehicle at a certain base.

Then, the vehicle name column 60A displays the vehicle name of the relevant transportation vehicle; and the location name column 60B displays the base name of a base where the relevant task is performed. Moreover, the status column 60C stores the status of the relevant task at that base regarding the transportation vehicle. Examples of the status of the transportation vehicle are “Departure” to depart from a parking space or the base, “Loading” to load packages onto the transportation vehicle at the base, “Relay” to hand over the packages to the next transportation vehicle at the relay base or to take over the packages from the previous transportation vehicle at the relay base, “Unloading” to unload the packages at the base, and “Arrival” to arrive at the destination.

The order number column 60D displays the order number corresponding to the relevant package(s) when the status is a task regarding the package(s); and the quantity column 60E displays the quantity of packages regarding which the relevant task is performed when the status is the task regarding the package(s). Moreover, the date-and-time column 60F is divided into a start column 60FA and an end column 60FB; and the start column 60FA displays a date and time to start the status displayed in the status column 60C and the end column 60FB displays a date and time to end that status.

Accordingly, in the case of an example in FIG. 16, for example, it is shown that a transportation schedule is created for a transportation vehicle with the vehicle name “Vehicle A” to “depart” from a parking space of a base called “Base 4” between “4/1 9:05” (which means “9:05 on April 1st”) to “4/1 9:13” (which means “9:13 on April 1st”) and head to a berth of that base, and “load” “8” packages corresponding to an order with the order number “5” between “4/1 9:05” and “4/1 9:13” at the relevant berth at the base.

Incidentally, the vehicle transportation schedule table 60 may display, instead of or in addition to the quantity of packages, the weight, volume, length, width, or height of the package(s), or a combination thereof. Moreover, an amount of time for the relevant transportation vehicle to stay at the relevant base may be used in place of the date(s) and time(s). Furthermore, the transportation schedule may be displayed in a Gantt chart with a date and time as a horizontal axis and each transportation vehicle as a vertical axis.

Moreover, in the vehicle transportation route display area 52, a transportation route(s) decided by the devised relay transportation plan for any one of the transportation vehicles designated by the user or for all the transportation vehicles is displayed. The transportation vehicle for which the transportation route is displayed can be selected from a pull-down menu which is not illustrated in the drawing and which is displayed when clicking on a pull-down button 61; and the vehicle name of the transportation vehicle which is then selected (when one transportation vehicle is selected), or a character string stating “All Vehicles” (when an option of all the transportation vehicles is selected) is displayed in a selected vehicle display column 62.

FIG. 16 shows a case where a transportation vehicle with the vehicle name “Vehicle A” is selected as the transportation vehicle for which a transportation route is displayed. Moreover, FIG. 16 shows an example where base marks 63 (“Q” in FIG. 16) indicating the respective bases managed as spot information at the locations according to the latitudes and longitudes of the relevant bases are displayed in the vehicle transportation route display area 52; and an arrow 64 indicating the order of the respective bases, which the transportation vehicle called “Vehicle A” should stop by among the above-mentioned bases and which are indicated by the respectively corresponding base marks 63, is displayed.

Furthermore, in the plan evaluation result display area 53, the evaluation results of the devised relay transportation plan from the respective three points of view, i.e., the “Delivery Delay,” the “Operating Time of Transportation Vehicle,” and the “Driver's Satisfaction Level” are displayed, respectively. In the case of this embodiment, the delivery delay evaluation value, the operating time evaluation value, and the driver's satisfaction level evaluation value which are calculated according to the aforementioned Expression (1) to Expression (3), respectively, are displayed as the evaluation results from the respective points of view.

Incidentally, in addition to the delivery delay evaluation value, the operating time evaluation value, and the driver's satisfaction level evaluation value, the values of the delivery delay parameter, the operating time parameter, and the driver's satisfaction level parameter may be displayed, respectively; and, for example, a total transportation cost and total transportation time may be further displayed as part of the evaluation results when the devised relay transportation plan is implemented.

### (1-4-2) Driver Schedule Display Screen

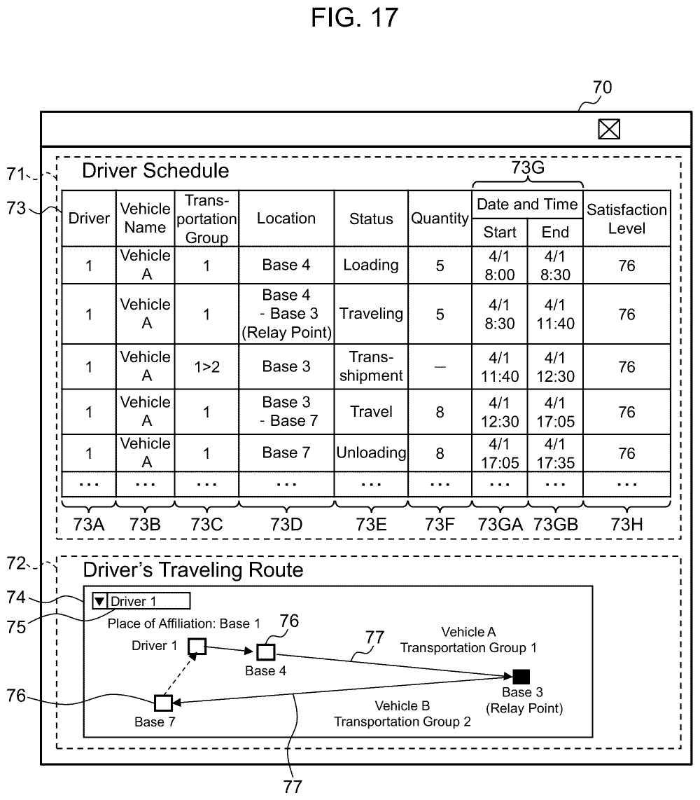

Meanwhile, FIG. 17 illustrates a structure example of a driver schedule display screen 70 showing transportation schedules of drivers, which is displayed on each driver's driver terminal 4 (FIG. 1) based on the processing results of the relay transportation plan devising processing transmitted from the proposed relay transportation plan evaluation unit 33 in step S8 of the relay transportation plan devising processing described earlier with reference to FIG. 12. This driver schedule display screen 70 is configured by including a driver schedule display area 71 and a driver traveling route display area 72.

Then, in the driver schedule display area 71, each driver's schedule created by the relay transportation plan devising processing (hereinafter referred to as a “driver schedule”) is displayed in a table format.

Practically, in the driver schedule display area 71, a driver schedule table 73 including a driver column 73A, a vehicle name column 73B, a transportation group column 73C, a location column 73D, a status column 73E, a quantity column 73F, a date-and-time column 73G, and a satisfaction level column 73H is displayed. In the driver schedule table 73, one record corresponds to the status of one task by one driver at one base.

Then, the driver column 73A displays the driver number of the relevant driver; and the status column 73E displays the status of a task to be performed by that driver. Examples of the “Task Status” are “Loading” to load packages onto the transportation vehicle, “Traveling” to travel between bases by driving the transportation vehicle, “Transshipment” to transship the packages to another transportation vehicle at a relay base, and “Unloading” to unload the packages from the transportation vehicle.

Moreover, the location column 73D displays the location where the relevant driver should perform the task or where the driver should be in the relevant status. For example, when the task status is “Loading,” “Transshipment,” or “Unloading,” the base name of a base where the relevant task is performed is displayed. Moreover, when the task status is “Traveling,” the base name of a base which is a departure place and the base name of a base which is an arrival place are displayed, respectively.

In the transportation group column 73C, the transportation group number of a transportation group to which target packages of the relevant task belong is displayed. In this case, when the task status is “Loading,” “Traveling,” or “Unloading,” the transportation group number of a transportation group composed of target packages is displayed; and when the task status is “Transshipment,” the transportation group number of a transportation group to which the packages before the transshipment belong, and the transportation group number of a transportation group to which the packages after the transshipment belong are displayed, respectively.

In the quantity column 73F, a total quantity of packages belonging to the relevant transportation group is displayed. However, when the task is “Transshipment,” the total quantity of packages is not displayed. Moreover, in the vehicle name column 73B, the vehicle name of a transportation vehicle which performs the relevant task is displayed. Furthermore, the date-and-time column 73G is divided into a start column 73GA and an end column 73GB; and a date and time when the status of the task displayed in the status column 73E should be started is displayed in the start column 73GA and a date and time when that status should be terminated is displayed in the end column 73GB.

Furthermore, in the satisfaction level column 73H, the satisfaction level of the relevant driver for the relevant task (hereinafter referred to as a “Driver's Satisfaction Level”) is displayed. The above-mentioned driver's satisfaction level is a numerical value calculated, for example, in accordance with the following expression.

$$[ Math . 5 ]$$

$$Driver ’ s Satisfaction Level = \qquad ( 5 )$$

$$The Number of Driver ’ s Personal Preferences Satisfied at The Relevant$$

$$Base / The Number of Driver ’ s Personal Preferences at That Base \times 100 \%$$

Accordingly, in the case of an example in FIG. 17, it is shown that a driver schedule designed as follows is created: the relevant driver to whom the driver number “1” is assigned loads “5” packages belonging to the transportation group called “1” onto the transportation vehicle called “Vehicle A” at a base called “Base 4” between “4/1 8:00” (which means “8:00 on April 1st”) and “4/1 8:30” (which means “8:30 on April 1st”); and then drives the transportation vehicle to “Travel” and move those packages to a relay base called “Base 3” between “4/1 8:30” (which means “8:30 on April 1st”) and “4/1 11:40” (which means “11:40 on April 1st”) (from “Base 4 to Base 3 (relay point)”). Moreover, FIG. 17 also shows that the user's satisfaction levels regarding the respective tasks of “Loading” and “Traveling” in this case are both “76”%.

Incidentally, the driver schedule table 73 may display, instead of or in addition to the quantity of packages, the weight, volume, length, width, or height of the package(s), or a combination thereof.

Moreover, in the driver traveling route display area 72, a traveling route for any one of drivers designated by the user or traveling routes for all the drivers, which is/are decided by the devised relay transportation plan is displayed. The driver for whom the traveling route is to be displayed can be selected from a pull-down menu which is not illustrated in the drawing and which is displayed when clicking on a pull-down button 74; and the driver number of the driver who is then selected (when one driver is selected), or a character string stating “All Drivers” (when an option of all the drivers is selected) is displayed in a selected driver display column 75.

FIG. 17 shows a case where a driver with the driver number “Driver 1” is selected as the driver for whom a traveling route is displayed. Moreover, FIG. 17 shows an example where base marks 76 (“Q” in FIG. 17) indicating the respective bases managed as spot information at the locations according to the latitudes and longitudes of the respective bases where the driver should stop by are displayed; and an arrow 77 linking between the base marks 76 corresponding to the respective bases, where the driver called “Driver 1” should stop by among these bases, in a sequential order for the driver to travel is displayed.

### (1-4-3) Vehicle Schedule Display Screen

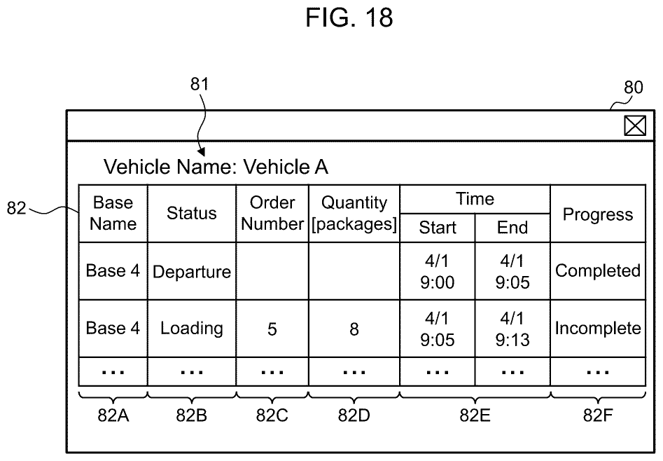

On the other hand, FIG. 18 illustrates a structure example of a transportation schedule display screen 80 showing a transportation schedule of the relevant transportation vehicle, which is displayed on the vehicle terminal 5 (FIG. 1) of each transportation vehicle on the basis of the processing result of the relay transportation plan devising processing which has been transmitted from the proposed relay transportation plan evaluation unit in step S8 of the relay transportation plan devising processing described earlier with reference to FIG. 12.

This transportation schedule display screen 80 displays: a character string 81 indicating the vehicle name of a transportation vehicle equipped with the vehicle terminal 5 on which the relevant transportation schedule display screen 80 is displayed; and a transportation schedule of that transportation vehicle, which is created by the relay transportation plan devising processing, in a table format.

Practically, the transportation schedule display screen 80 displays a transportation schedule table 82 including a base name column 82A, a status column 82B, an order number column 82C, a quantity column 82D, a time column 82E, and a progress column 82F. In the transportation schedule table 82, one record corresponds to one status at a base where the transportation vehicle is located.

Then, the base name column 82A, the status column 82B, the order number column 82C, the quantity column 82D, and the time column 82E respectively display the content similar to that displayed regarding the relevant transportation vehicle in the location name column 60B, the status column 60C, the order number column 60D, the quantity column 60E, and the date-and-time column 60F of the vehicle transportation schedule table 60 of the result summary display screen 50 described earlier with reference to FIG. 16.

Moreover, the progress column 82F stores information indicating the progress status of a task displayed in the status column 82B. FIG. 18 shows an example of a case where: “Completed” is displayed when the task is completed; and “Incomplete” is displayed when the task is not completed. Incidentally, in the case of this embodiment, it is designed so that every time the driver finishes one task indicated in the transportation schedule table 82, the driver performs a specified input of completion of the task to the driver terminal 4; and whether a certain task is completed or not is judged by the proposed relay transportation plan evaluation unit 33 for the relay transportation planning apparatus 2 based on the above-mentioned input and the judgment result is displayed in the progress column 82F.

This transportation schedule display screen 80 enables the driver to check the transportation schedule of the transportation vehicle which that driver should drive, and the progress status of each task according to the transportation schedule.

### (1-4-4) Base Plan Display Screen

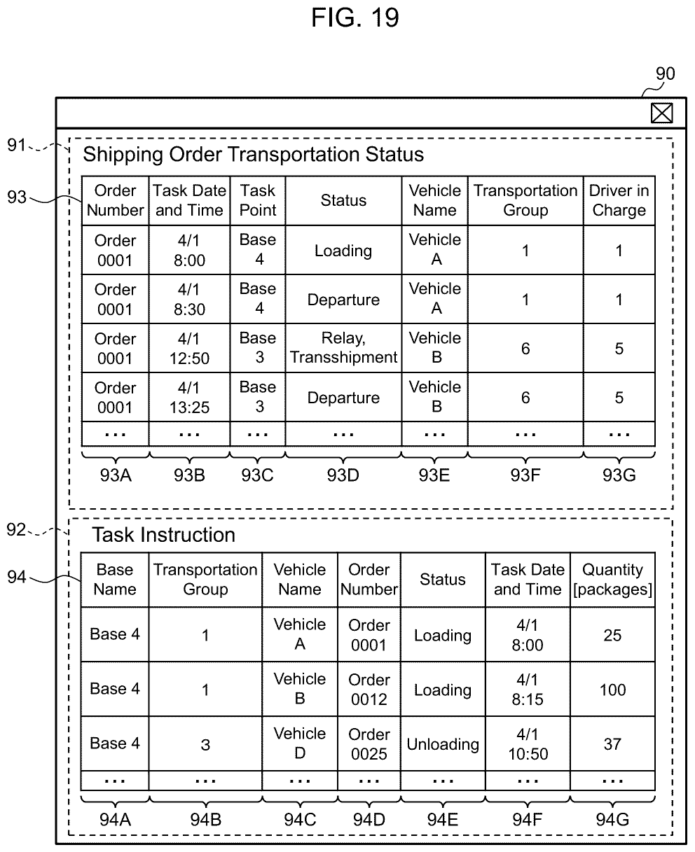

On the other hand, FIG. 19 illustrates a structure example of a base plan display screen 90 which displays a task plan, etc. at the relevant base and which is displayed on the base plan management terminal 6 (FIG. 1) of each relevant base on the basis of the processing result of the relay transportation plan devising processing transmitted from the proposed relay transportation plan evaluation unit 33 in step S8 of the relay transportation plan devising processing described earlier with reference to FIG. 12. This base plan display screen 90 is configured by including a shipping order transportation status display area 91 and a task instruction display area 92.

Then, in the shipping order transportation status display area 91, a task schedule for a shipping order from the relevant base according to the best plan is displayed.

Practically, in the shipping order transportation status display area 91, a task schedule table 93 including an order number column 93A, a task date-and-time column 93B, a task point column 93C, a status column 93D, a vehicle name column 93E, a transportation group column 93F, and a driver-in-charge column 93G is displayed. In the task schedule table 93, one record corresponds to one task to be performed at any one of bases regarding packages shipped from the relevant base according to a certain order.

Then, the order number column 93A displays the order number of the relevant order; and the task date-and-time column 93B displays a date and time to perform the relevant task. Moreover, the task point column 93C displays the base name of a base where the task is to be performed; and the status column 93D displays the status of that task. Examples of the “Task Status” include “Departure,” “Loading,” “Relay (including the transshipment, the driver change, etc.),” “Unloading,” and “Arrival” which have been described earlier.

Furthermore, the vehicle name column 93E displays the vehicle name of a transportation vehicle to perform the task of the relevant packages; and the transportation group column 93F displays the transportation group number of a transportation group to which the relevant packages belong. Furthermore, the driver-in-charge column 93G displays the driver number of a driver allocated to that transportation vehicle.

Accordingly, in the case of an example in FIG. 19, it is shown that, for example, regarding a package(s) belonging to the transportation group called “1” for which a transportation request is made by an order with the order number “Order 0001,” a task to load (“Loading”) the package(s) onto a transportation vehicle called “Vehicle A,” of which a driver with the assigned driver number “1” takes charge, at a base called “Base 4” will be started at “4/1 8:00” (which means “8:00 on April 1st”) and the transportation vehicle will “depart” from that base at “4/1 8:30” (which means “8:30 on April 1st”).

Moreover, FIG. 19 also shows that this package(s) will be transshipped to a transportation vehicle called “Vehicle B,” of which a driver with the driver number “5” takes charge, at a base called “Base 3” at “4/1 12:50” (which means “12:50 on April 1st”) (“Relay, Transshipment”) and then the transportation vehicle will depart from that base at “4/1 13:25” (which means “13:25 on April 1st”).

Incidentally, the task schedule table 93 may include information about the quantity, weight, volume, length, width, and height of target packages of the relevant task, or a combination thereof. Moreover, the task date and time may be divided into a starting date and time when the relevant task should be started, and an ending date and time when that task should be finished, and they may be displayed separately. Furthermore, in place of the task schedule table 93, a schedule for each aforementioned task may be displayed as a Gantt chart with a date and time as a horizontal axis and each vehicle as a vertical axis.

Moreover, in the task instruction display area 92, the content of each task which should be executed on each package belonging to each transportation group at each base is displayed.

Practically, in the task instruction display area 92, a task instruction list 94 including a base name column 94A, a transportation group column 94B, a vehicle name column 94C, an order number column 94D, a status column 94E, a task date-and-time column 94F, and a quantity column 94G is displayed. In the task instruction list 94, one record corresponds to a task which should be executed on a certain package(s) at a certain base.

Then, the base name column 94A displays the base name of a base where the relevant task should be executed; and the status column 94E displays the status of that task. Moreover, the task date-and-time column 94F displays a date and time when the relevant task should be performed at the relevant base; and the vehicle name column 94C displays the vehicle name of a transportation vehicle for performing the task with respect to the relevant package(s).

Furthermore, the transportation group column 94B displays the transportation group number of a transportation group to which the target package(s) of the relevant task belong; and the order number column 94D displays the order number of the relevant order regarding the package(s). Furthermore, the quantity column 94G displays the quantity of the package(s) regarding that order.

Accordingly, in the case of an example in FIG. 19, it is shown that an instruction is issued to “load” “25” packages, which are requested by the order with the order number “Order 0001” and belong to the transportation group with the transportation group number “1,” onto the transportation vehicle called “Vehicle A” at the base called “Base 4” at “4/1 8:00” (which means “8:00 on April 1st”).

### (1-5) Advantageous Effects of this Embodiment

In this embodiment as described above, a transportation plan is created by forming one or a plurality of transportation groups by gathering packages which have an at least partly overlapping transportation route and which share a common time slot for the transportation via the transportation route; and allocating a transportation vehicle and a driver to each created transportation group.

Accordingly, if the relay transportation planning apparatus 2 according to this embodiment is employed, for example, even when there is no package from a first base to a second base and there is a package(s) to be transported from the second base to the first base or a third base, it is possible to devise a relay transportation plan which is not a transportation plan designed for a driver to drive an empty vehicle from the first base to the second base, but is a relay transportation plan for the driver to travel to the second base, for example, by car or train and then drive a transportation vehicle located at the second base to transport the package(s) to the first or third base, so that it is possible to prevent degradation of package transportation efficiency attributable to the empty car driving.

Additionally, in this embodiment, a plurality of the transportation vehicles for performing platooning or the transportation vehicle for towing a plurality of towed vehicles is allocated to a transportation group as necessary, so that a transportation amount per driver can be increased and the package transportation efficiency can be further enhanced.

### (2) Second Embodiment

The first embodiment has described the case where a transportation means for transporting packages (hereinafter referred to as a “transportation apparatus”) is a vehicle. On the contrary, in this embodiment, an explanation will be provided about a case where the transportation apparatus is expanded and, for example, trains, ships, and/or airplanes can be also used as the transportation apparatus(es) to transport packages to a relay base and transport the packages from the relay base.

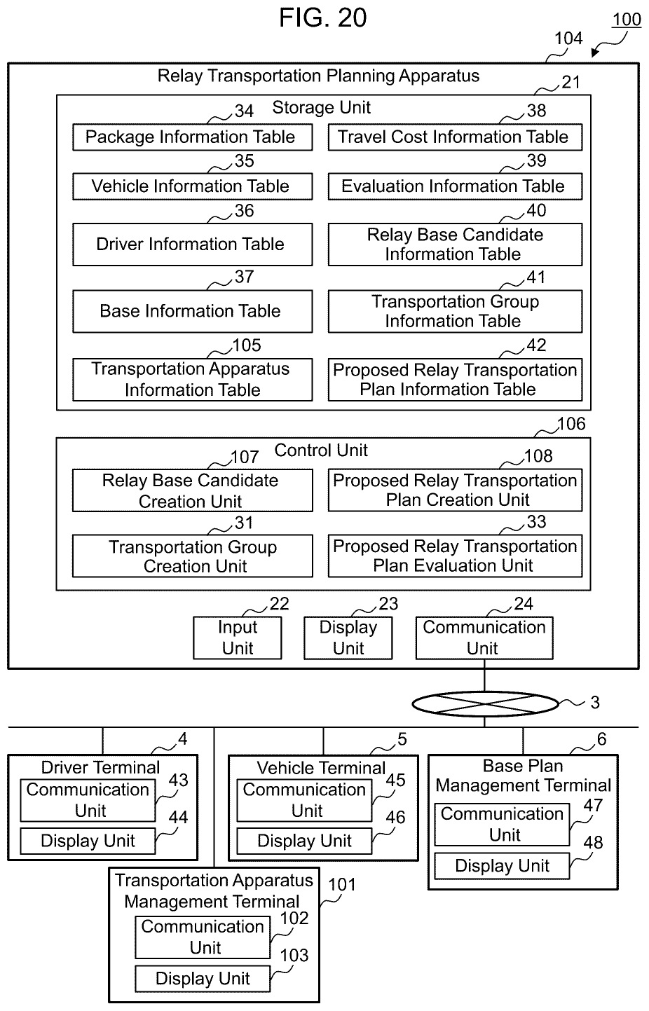

FIG. 20, which shows parts corresponding to those in FIG. 2 by assigning the same reference numerals to them as those in FIG. 2, illustrates a logical configuration of a relay transportation planning system 100 according to a second embodiment. The significant difference between this relay transportation planning system 100 and the relay transportation planning system 1 according to the first embodiment is that a transportation apparatus management terminal 101 is connected to the network 3. Incidentally, a hardware configuration of the relay transportation planning system 100 according to this embodiment is similar to that of the relay transportation planning system 1 according to the first embodiment, except that the transportation apparatus management terminal 101 is provided. So, an explanation about the hardware configuration of the relay transportation planning system 100 has been omitted here.

The transportation apparatus management terminal 101 is an information processing terminal for managing a transportation schedule for the transportation apparatus(es) such as trains, ships, and/or airplanes other than the transportation vehicle(s) and is configured from, for example, a general-purpose computer apparatus. This transportation apparatus management terminal 101 includes, as functional units, a communication unit 102 and a display unit 103. The communication unit 102 is a functional unit having a function that transmits service schedules for managing the respective transportation apparatuses which it manages, to the relay transportation planning apparatus 104. Moreover, the display unit 103 is a functional unit having a function that visualizes and displays necessary information, which has been received by the communication unit 102, on a display device (which is not illustrated in the drawing) included in the transportation apparatus management terminal 101.

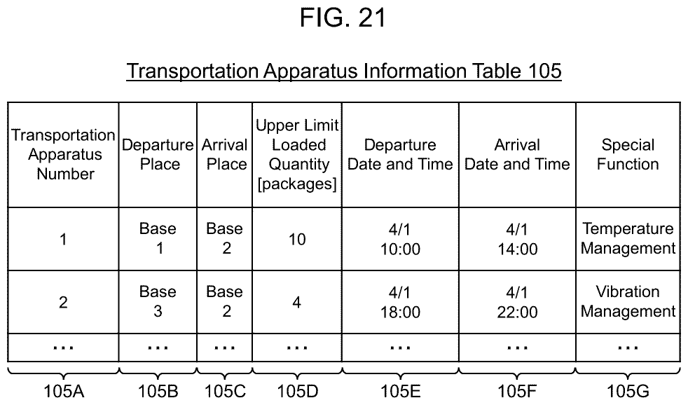

Moreover, the difference between the relay transportation planning apparatus 104 according to this embodiment and the relay transportation planning apparatus 2 according to the first embodiment is that the storage unit 21 for the relay transportation planning apparatus 104 stores and retains a transportation apparatus information table 105 illustrated in FIG. 21 in addition to the package information table 34, the vehicle information table 35, the driver information table 36, the base information table 37, the travel cost information table 38, the evaluation information table 39, the relay base candidate information table 40, the transportation group information table 41, and the proposed relay transportation plan information table 42 which are described earlier with reference to FIG. 3 to FIG. 11.

The transportation apparatus information table 105 is a table for managing service schedules of various kinds of transportation apparatuses other than the transportation vehicles and is configured by including, as illustrated in FIG. 21, a transportation apparatus number column 105A, a departure place column 105B, an arrival place column 105C, an upper limit loaded quantity column 105D, a departure date-and-time column 105E, an arrival date-and-time column 105F, and a special function column 105G. In the transportation apparatus information table 105, one record corresponds to one service trip of one transportation apparatus.

Then, the transportation apparatus number column 105A stores a unique transportation apparatus number of the relevant transportation apparatus, which is assigned to that transportation apparatus. Incidentally, this transportation apparatus number is assigned to each train, each ship, and each airplane which can be used to transport packages.

Moreover, the departure place column 105B stores the base name of a base which is a departure place of the relevant transportation apparatus for the relevant service trip; and the arrival place column 105C stores the base name of a base which is an arrival place of the relevant transportation apparatus for the relevant service trip. Furthermore, the upper limit loaded quantity column 105D stores an upper limit quantity of packages which can be loaded onto that transportation apparatus. Incidentally, regarding this upper limit loaded quantity, for example, an upper limit quantity of containers in which the packages will be placed may be applied instead of the upper limit quantity of the packages.

The departure date-and-time column 105E stores a date and time when the relevant transportation apparatus for the relevant service trip departs from the above-mentioned departure place; and the arrival date-and-time column 105F stores a date and time when the relevant transportation apparatus for the relevant service trip arrives at the above-mentioned arrival place. Moreover, the special function column 105G stores a special function with which the relevant transportation apparatus is equipped. The special function herein used is a function similar to the special function(s) of the transportation vehicle which is registered in the vehicle information table 35.

Accordingly, in the case of an example in FIG. 21, it is shown that a transportation apparatus to which the transportation apparatus number “1” is assigned has a service schedule to depart from a base called “Base 1” at “4/1 10:00” (which means “10:00 on April 1^{st}”) and arrive at a base called “Base 2” at “4/1 14:00” (which means “14:00 on April 1^{st}”); the quantity of packages or containers which can be loaded onto the transportation apparatus is “10”; and that transportation apparatus is equipped with the function of “Temperature Management.”

Next, regarding this relay transportation planning system 100, an explanation will be provided about a flow of relay transportation plan devising processing executed by the relay transportation planning apparatus 104 when the input unit 22 for the relay transportation planning apparatus 104 accepts a relay transportation plan devising instruction from the user.

The relay transportation plan devising processing executed by this relay transportation planning apparatus 104 is basically similar to the relay transportation plan devising processing in the first embodiment described earlier with reference to FIG. 12.

However, in the case of this embodiment, in step S1 of the relay transportation plan devising processing, a relay base candidate creation unit 107 of a control unit 106 for the relay transportation planning apparatus 104 reads, in addition to the package information, the vehicle information, the driver information, the base information, the travel cost information, and the evaluation information described earlier, the service schedule for each transportation apparatus from a portable storage medium via the media reading device 16 (FIG. 1). Then, the relay base candidate creation unit 107 stores the read service schedule for each transportation apparatus in the transportation apparatus information table 105.

Moreover, in step S2 of the relay transportation plan devising processing when deciding a relay base candidate for each order, the relay base candidate creation unit 107 decides each relay base candidate for each order regarding a route for which a transportation apparatus whose service schedule is registered in the transportation apparatus information table 105, by using an average value of travel time between a pickup place of the package information and a departure place of the transportation apparatus, and travel time between a delivery place of the package information and an arrival place of the transportation apparatus, respectively.

Specifically, the relay base candidate creation unit 107 decides a relay base candidate(s) for each order so that a total value of the travel time between the pickup location base and the relay base and the travel time between the relay base and the delivery destination base will become short and a relay base candidate combination which is different from relay base candidate combinations which have ever created can be generated.

Furthermore, in step S5 of the relay transportation plan devising processing when allocating a transportation vehicle to each transportation group, a proposed relay transportation plan creation unit 108 allocates the relevant transportation apparatus, instead of the transportation vehicle, to the relevant transportation group if the starting point and the ending point of the transportation group match the departure place and the arrival place of any one of transportation apparatuses, respectively, and the possible departure date and time of that transportation group from the starting point is before the departure date and time of the transportation apparatus, and a deadline of arrival of the transportation group at the ending point is after the arrival time of day of the transportation apparatus. Incidentally, no driver is allocated to the transportation apparatus.

Incidentally, when the transportation apparatus is allocated to the transportation group as described above, information about the transportation apparatus may be placed on the result summary display screen 50 described earlier with reference to FIG. 16 to be displayed on the display device 15 (FIG. 1) of the relay transportation planning apparatus 2.

When the relay transportation planning system 100 according to this embodiment which has the above-described configuration is employed, a relay transportation plan which also uses the transportation apparatus other than the transportation vehicle can be devised, so that it is possible to devise the relay transportation plan(s) which further enhances the package transportation efficiency.

### (3) Third Embodiment

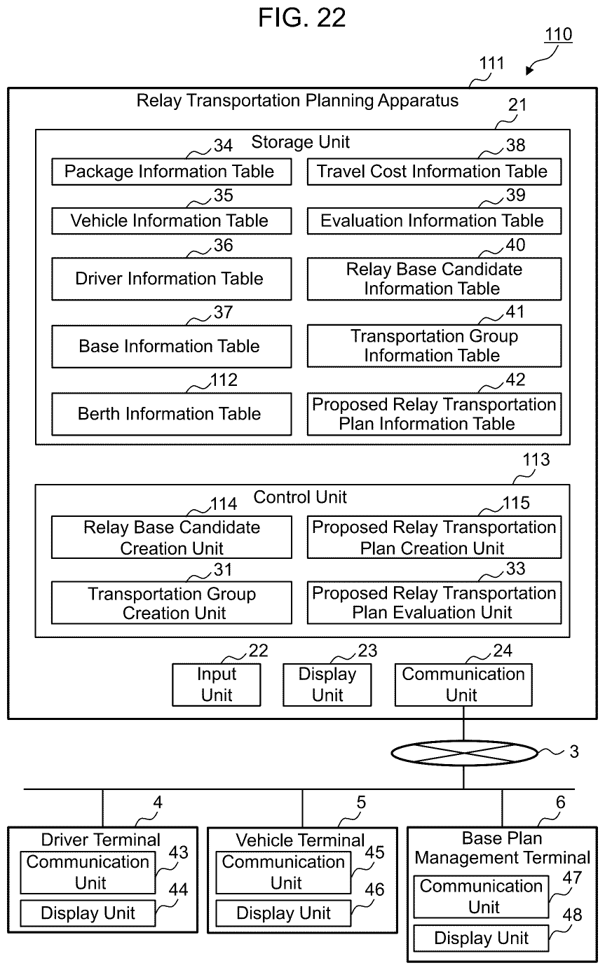

FIG. 22, which shows parts corresponding to those in FIG. 1 by assigning the same reference numerals to them as those in FIG. 1, illustrates a logical configuration of a relay transportation planning system 110 according to a third embodiment. The difference between this relay transportation planning system 110 and the first embodiment is that a storage unit 21 for a relay transportation planning apparatus 111 stores and retains a berth information table 112 in addition to the package information table 34, the vehicle information table 35, the driver information table 36, the base information table 37, the travel cost information table 38, the evaluation information table 39, the relay base candidate information table 40, the transportation group information table 41, and the proposed relay transportation plan information table 42.

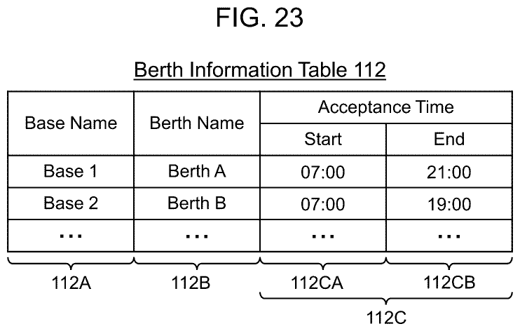

The berth information table 112 is a table used to manage acceptance time to accept a transportation vehicle in a berth provided at each base and is configured by including, as illustrated in FIG. 23, a base name column 112A, a berth name column 112B, and an acceptance time column 112C. In the berth information table 112, one record corresponds to one berth provided at any one of bases.

Then, the base name column 112A stores the base name of a base provided with the relevant berth; and the berth name column 112B stores a unique name of the relevant berth (berth name) which is assigned to that berth. Furthermore, the acceptance time column 112C is divided into a start column 112CA and an end column 112CB; and the start column 112CA stores starting time to start accepting the transportation vehicle at the relevant berth and the end column 112CB stores ending time to finish accepting the transportation vehicle at that berth.

Accordingly, in the case of an example in FIG. 23, it is shown that the acceptance time of the transportation vehicle at the berth with the berth name “Berth A” provided at the base called “Base 1” is from “07:00” to “21:00.”

Next, an explanation will be provided about a flow of relay transportation plan devising processing executed by the relay transportation planning apparatus 111 when the input unit 22 for the relay transportation planning apparatus 111 in this relay transportation planning system 110 accepts a relay transportation plan devising instruction from the user.

The relay transportation plan devising processing executed by this relay transportation planning apparatus 111 is basically similar to the relay transportation plan devising processing according to the first embodiment described earlier with reference to FIG. 12.

However, in the case of this embodiment, in step S1 of the relay transportation plan devising processing, a relay base candidate creation unit 114 of a control unit 113 for the relay transportation planning apparatus 111 reads, in addition to the package information, the vehicle information, the driver information, the base information, the travel cost information, and the evaluation information described earlier, the acceptance time to accept the transportation apparatus at a berth of each base, as berth information, from a portable storage medium via the media reading device 16 (FIG. 1). Then, the relay base candidate creation unit 114 stores the read berth information in the berth information table 112.

Moreover, in step S5 of the relay transportation plan devising processing, when deciding the date and time for the transportation vehicle to depart from the relevant relay base after the arrival at that relay base, a proposed relay transportation plan creation unit 115 identifies a berth which is not used after the arrival of that transportation vehicle at the relay base until its departure, based on the berth information stored in the berth information table 112 and allocates that berth to the transportation vehicle.

Incidentally, if the transportation apparatus is allocated to a transportation group as described above, information about the relevant berth may be also placed on the result summary display screen 50 described earlier with reference to FIG. 16 to be displayed on the display device 15 (FIG. 1) of the relay transportation planning apparatus 2.

When the relay transportation planning system 110 according to this embodiment which has the above-described configuration is employed, it is possible to obtain the advantageous effect capable of devising a more detailed relay transportation plan(s) in addition to the advantageous effects which can be obtained by the first embodiment.

### (4) Other Embodiments

Incidentally, the aforementioned first to third embodiments have described the case where the relay transportation planning apparatus 2, 104, 111 is configured from one general-purpose computer apparatus; however, the present invention is not limited to this example and the relay transportation planning apparatus 2, 104, 111 may be configured from a distributed computing system which is composed of a plurality of computer apparatuses.

Moreover, the aforementioned first to third embodiments have described the case where only zero or one relay base candidate is decided between the pickup location base and the delivery destination base; however, the present invention is not limited to this example and two or more relay base candidates may be decided.

Furthermore, the aforementioned first to third embodiments have described the case where the proposed relay transportation plan evaluation unit 33 comprehensively evaluates the proposed relay transportation plan(s) from the three points of view, i.e., the “Delivery Delay,” the “Operating Time,” and the “Driver's Satisfaction Level”; however, the present invention is not limited to this example and the proposed relay transportation plan evaluation unit 33 may evaluate the proposed relay transportation plan(s) from any points of view other than those mentioned above.

### INDUSTRIAL AVAILABILITY

The present invention can be applied to a wide variety of transportation planning apparatuses for creating transportation plans for packages for which a transportation request(s) is made.

### REFERENCE SIGNS LIST

1, 100, 110: relay transportation planning system
2, 104, 111: relay transportation planning apparatus
4: driver terminal
5: vehicle terminal
6: base plan management terminal
10: CPU
15: display device
20, 106, 113: control unit
30, 107, 114: relay base candidate creation unit
31: transportation group creation unit
32, 108, 115: proposed relay transportation plan creation unit
33: proposed relay transportation plan evaluation unit
34: package information table
35: vehicle information table
36: driver information table
37: base information table
38: travel cost information table
39: evaluation information table
40: relay base candidate information table
41: transportation group information table
42: proposed relay transportation plan information table
50: result summary display screen
70: driver schedule display screen
80: transportation schedule display screen
90: base plan display screen
101: transportation apparatus management terminal
105: transportation apparatus information table
112: berth information table

1. A transportation planning apparatus for creating transportation plans to transport packages for which transportation requests are made,
the transportation planning apparatus comprising:
a storage unit that stores and retains package information which is information about each of the requested packages, vehicle information which is information about each of transportation vehicles for transporting the packages, and driver information which is information about each of drivers who drive the transportation vehicles, respectively; and
a control unit that creates the transportation plan by forming one or a plurality of transportation groups by gathering the packages which have an at least partly overlapping transportation route and share a common time slot for transportation via the transportation route, based on the package information, the vehicle information, and the driver information and allocating the transportation vehicle and the driver to each of the created transportation groups,
wherein the control unit allocates a plurality of the transportation vehicles, which perform platooning, or the transportation vehicle for towing a plurality of towed vehicles to the transportation group as necessary.

2. The transportation planning apparatus according to claim 1,
wherein the control unit includes:
a relay base candidate creation unit that creates a relay base candidate, which is a candidate for a relay base where the packages to be transported are relayed, for each of the transportation requests;
a transportation group creation unit that forms one or a plurality of transportation groups by gathering the packages which have an at least partly overlapping transportation route via the relevant relay base candidate, and which share a common time slot for transportation via the transportation route; and
a transportation plan creation unit that creates the transportation plan by allocating the transportation vehicle and the driver to each of the created transportation groups.

3. The transportation planning apparatus according to claim 2,
wherein the relay base candidate creation unit generates relay base combinations of multiple patterns by changing the relay base for each of some or all of the transportation requests;
wherein the transportation group creation unit creates one or a plurality of the transportation groups for each of the generated relay base combinations; and
wherein the transportation plan creation unit creates, for each of the relay base combinations, the transportation plan by allocating the transportation vehicle and the driver to each of the created transportation groups; and
wherein the transportation planning apparatus further includes a transportation plan evaluation unit that evaluates each of the transportation plans created by the transportation plan creation unit and outputs the transportation plan which is most highly evaluated.

4. The transportation planning apparatus according to claim 2,
wherein when a package amount of the packages which will arrive at the relay base candidate within a specified amount of time and are addressed to a specified delivery destination base is larger than the package amount of the packages which can be transported by one of the transportation vehicles, or when a quantity of the transportation vehicles which will transport the packages addressed to the specified delivery destination base within a specified amount of time is larger than the quantity of the transportation vehicles which should depart from the relay base candidate to the delivery destination base within the specified amount of time, the transportation plan creation unit allocates the plurality of the transportation vehicles, which perform platooning, or the transportation vehicle for towing the plurality of towed vehicles to the transportation group which transports the packages from the relay base candidate to the delivery destination base within the specified amount of time; and
when an amount of the packages which have the overlapping transportation route and share the common time slot for transportation via the transportation route is equal to or more than a specified quantity within a specified amount of time, the transportation plan creation unit allocates the plurality of the transportation vehicles, which perform platooning, or the transportation vehicle for towing the plurality of towed vehicles to the transportation group which transports the packages via the transportation route during the time slot.

5. The transportation planning apparatus according to claim 1,
wherein the storage unit stores a request for a means of transport for each of the drivers from a base which is a place of affiliation to a relay base or a delivery destination base; and
wherein the control unit decides the driver to be allocated to each of the transportation groups based on the request for the means of transport for each of the drivers.

6. The transportation planning apparatus according to claim 1,
wherein the control unit creates the transportation group in consideration of a restriction on a quantity of the transportation vehicles capable of platooning at the same time or a restriction on a quantity of the towed vehicles which can be towed at the same time, a restriction on packages to be loaded onto each of the transportation vehicles to be platooned or the plurality of transportation vehicles which can be platooned at the same time, or a restriction on packages to be loaded onto the towed vehicles which can be towed at the same time by the transportation vehicle.

7. A transportation planning method executed by a transportation planning apparatus for creating transportation plans for which transportation requests are made,
the transportation planning method comprising:
a first step of storing and retaining package information which is information about each of the requested packages, vehicle information which is information about each of transportation vehicles for transporting the packages, and driver information which is information about each of drivers who drive the transportation vehicles, respectively; and
a second step of creating the transportation plan by forming one or a plurality of transportation groups by gathering the packages which have an at least partly overlapping transportation route and share a common time slot for transportation via the transportation route, based on the package information, the vehicle information, and the driver information and allocating the transportation vehicle and the driver to each of the created transportation groups,
wherein in the second step, the transportation planning apparatus allocates a plurality of the transportation vehicles, which perform platooning, or the transportation vehicle for towing a plurality of towed vehicles to the transportation group as necessary.

8. The transportation planning method according to claim 7,
wherein the second step includes:
a relay base candidate creation step of creating a relay base candidate, which is a candidate for a relay base where the packages to be transported are relayed, for each of the transportation requests;
a transportation group creation step of forming one or a plurality of transportation groups by gathering the packages which have an at least partly overlapping transportation route via the relevant relay base candidate, and which share a common time slot for transportation via the transportation route; and
a transportation plan creation step of creating the transportation plan by allocating the transportation vehicle and the driver to each of the created transportation groups.

9. The transportation planning method according to claim 8,
wherein in the relay base candidate creation step, relay base combinations of multiple patterns are generated by changing the relay base for each of some or all of the transportation requests;
wherein in the transportation group creation step, one or a plurality of the transportation groups are created for each of the generated relay base combinations; and
wherein in the transportation plan creation step, the transportation plan is created for each of the relay base combinations, by allocating the transportation vehicle and the driver to each of the created transportation groups; and
wherein the transportation planning method further includes a transportation plan evaluation step of evaluating each of the transportation plans created by the transportation plan creation step and outputs the transportation plan which is most highly evaluated.

10. The transportation planning method according to claim 8,
wherein in the transportation plan creation step, when a package amount of the packages which will arrive at the relay base candidate within a specified amount of time and are addressed to a specified delivery destination base is larger than the package amount of the packages which can be transported by one of the transportation vehicles, or when a quantity of the transportation vehicles which will transport the packages addressed to the specified delivery destination base within a specified amount of time is larger than the quantity of the transportation vehicles which should depart from the relay base candidate to the delivery destination base within the specified amount of time, the plurality of the transportation vehicles, which perform platooning, or the transportation vehicle for towing the plurality of towed vehicles is allocated to the transportation group which transports the packages from the relay base candidate to the delivery destination base within the specified amount of time; and
when an amount of the packages which have the overlapping transportation route and share the common time slot for transportation via the transportation route is equal to or more than a specified quantity within a specified amount of time, the plurality of the transportation vehicles, which perform platooning, or the transportation vehicle for towing the plurality of towed vehicles is allocated to the transportation group which transports the packages via the transportation route during the time slot.

11. The transportation planning method according to claim 7,
wherein in the first step, the transportation planning apparatus stores a request for a means of transport for each of the drivers from a base which is a place of affiliation to a relay base or a delivery destination base; and
wherein in the second step, the transportation planning apparatus decides the driver to be allocated to each of the transportation groups based on the request for the means of transport for each of the drivers.

12. The transportation planning method according to claim 7,
wherein in the second step, the transportation planning apparatus creates the transportation group in consideration of a restriction on a quantity of the transportation vehicles capable of platooning at the same time or a restriction on a quantity of the towed vehicles which can be towed at the same time, a restriction on packages to be loaded onto each of the transportation vehicles to be platooned or the plurality of transportation vehicles which can be platooned at the same time, or a restriction on packages to be loaded onto the towed vehicles which can be towed at the same time by the transportation vehicle.
